(19) United States
(12) Patent Application Publication
(10) Pub. No.: US 2025/0314044 A1
(43) Pub. Date: Oct. 9, 2025

(54) HYDRAULIC SYSTEM FOR WORKING MACHINE, AND WORKING MACHINE

(71) Applicant: Kubota Corporation, Osaka (JP)

(72) Inventors: Yuki BUNRYO, Sakai-shi (JP); Daiki ABE, Sakai-shi (JP); Ryuki NISHIMOTO, Sakai-shi (JP)

(21) Appl. No.: 19/098,001

(22) Filed: Apr. 2, 2025

(30) Foreign Application Priority Data
Apr. 5, 2024 (JP) 2024-061637

(51) Int. Cl. E02F 9/22; E02F 3/34; E02F 3/42; E02F 3/43; E02F 3/96; E02F 9/20; F15B 11/17; F15B 15/18; F15B 21/00

(52) U.S. Cl. CPC E02F 9/2203; E02F 9/2004; E02F 9/2292; E02F 9/2296; F15B 11/17; F15B 15/18; F15B 21/001; E02F 3/3414; E02F 3/422; E02F 3/431; E02F 3/96; E02F 9/2285

(57) ABSTRACT

A hydraulic system includes a prime mover, a variable displacement first hydraulic pump to be driven by the prime mover to deliver hydraulic fluid, a first hydraulic actuator to be driven by fluid delivered by the first hydraulic pump, a variable displacement second hydraulic pump to be driven by the prime mover to deliver hydraulic fluid, a second hydraulic actuator to be driven by fluid delivered by the second hydraulic pump, and first and second restrictors configured or programmed to restrict an output of the respective first and second hydraulic pumps based on a load on the prime mover. The first restrictor is configured or programmed to change an output restriction of the first hydraulic pump based on priority information about the first and second hydraulic actuators and/or the second restrictor is configured or programmed to change an output restriction of the second hydraulic pump based on the priority information.

### CROSS REFERENCE TO RELATED APPLICATIONS

This application claims the benefit of priority to Japanese Patent Application No. 2024-061637 filed on Apr. 5, 2024. The entire contents of this application are hereby incorporated herein by reference.

### BACKGROUND OF THE INVENTION

### 1. Field of the Invention

The present invention relates to hydraulic systems for working machines and relates to working machines.

### 2. Description of the Related Art

A hydraulic system for a working machine disclosed in Japanese Unexamined Patent Application Publication No. 2023-025934 includes a prime mover, a hydraulic actuator, a control valve that controls operation of the hydraulic actuator, a first hydraulic pump that is driven by power from the prime mover and delivers a pilot oil for switching the control valve, a variable displacement second hydraulic pump that is driven by power from the prime mover and delivers a hydraulic fluid for causing the hydraulic actuator to operate, a first fluid passage on which a maximum load pressure during operation of the hydraulic actuator can act, a second fluid passage on which a delivery pressure of the hydraulic fluid from the second hydraulic pump can act, a hydraulic pressure controller that sets a load sensing (LS) differential pressure, which is a pressure difference between the delivery pressure of the second hydraulic pump and the maximum load pressure, by controlling the second hydraulic pump, a third fluid passage through which the first hydraulic pump delivers the pilot oil, a fourth fluid passage that branches from the third fluid passage, a solenoid valve that changes a pilot pressure, which is a pressure of the pilot oil that flows through the fourth fluid passage and acts on the hydraulic pressure controller, and a controller that changes the LS differential pressure by controlling operation of the solenoid valve and thus adjusting the pilot pressure, and the controller changes the LS differential pressure in accordance with a load that acts on the prime mover.

Furthermore, the hydraulic system of the working machine disclosed in Japanese Unexamined Patent Application Publication No. 2023-025934 includes a traveling pump that operates by power from the prime mover, an operation valve that controls the traveling pump by the pilot oil delivered by the first hydraulic pump, and an actuated valve that is provided in the third fluid passage and changes the pilot pressure of the pilot oil supplied from the first hydraulic pump to the operation valve, and the controller lowers the pilot pressure that acts on the operation valve by controlling the actuated valve in accordance with the load that acts on the prime mover.

### SUMMARY OF THE INVENTION

In the hydraulic system of the working machine disclosed in Japanese Unexamined Patent Application Publication No. 2023-025934, stalling of the prime mover can be prevented or reduced by changing an output of the second hydraulic pump and the traveling pump in accordance with the load on the prime mover. However, more accurate horsepower control is required.

Example embodiments of the present invention provide hydraulic systems for working machines, each of which makes it possible to eliminate or reduce the likelihood that a prime mover will stall and to achieve improved working performance.

A hydraulic system for a working machine according to an example embodiment of the present invention includes a prime mover, a variable displacement first hydraulic pump to be driven by power from the prime mover to deliver hydraulic fluid, a first hydraulic actuator to be driven by hydraulic fluid delivered by the first hydraulic pump, a variable displacement second hydraulic pump to be driven by power from the prime mover to deliver hydraulic fluid, the second hydraulic pump being different from the first hydraulic pump, a second hydraulic actuator to be driven by hydraulic fluid delivered by the second hydraulic pump, a first restrictor configured or programmed to restrict an output of the first hydraulic pump in accordance with a load on the prime mover, and a second restrictor configured or programmed to restrict an output of the second hydraulic pump in accordance with the load on the prime mover, wherein the first restrictor is configured or programmed to change an output restriction of the first hydraulic pump in accordance with priority information relating to the first hydraulic actuator and the second hydraulic actuator and/or the second restrictor is configured or programmed to change an output restriction of the second hydraulic pump in accordance with the priority information.

The first restrictor may be configured or programmed to restrict the output of the first hydraulic pump in accordance with the load on the prime mover irrespective of a drive state of the first hydraulic actuator. The second restrictor may be configured or programmed to restrict the output of the second hydraulic pump in accordance with a drive state of the second hydraulic actuator in addition to the load on the prime mover.

The first restrictor may be configured or programmed to restrict the output of the first hydraulic pump in accordance with a drop rotational speed which is a difference between a target rotational speed of the prime mover and an actual rotational speed of the prime mover.

The second restrictor may be configured or programmed to control the second hydraulic pump to control a pressure difference between a delivery pressure of the second hydraulic pump and a maximum load pressure during actuation of the second hydraulic actuator at a predetermined pressure difference based on the load on the prime mover.

The hydraulic system may further include a first operating assembly to be operated to control driving of the first hydraulic actuator. The second restrictor may be configured or programmed to acquire the priority information based on an operation of the first operating assembly and change the output restriction such that the output of the second hydraulic pump is restricted more when the driving of the first hydraulic actuator is being controlled by the operation than when the driving of the first hydraulic actuator is not being controlled by the operation.

The second restrictor may be configured or programmed to, when the driving of the first hydraulic actuator is being controlled by the operation, acquire the drive state of the first hydraulic actuator and change the output restriction such that the output of the second hydraulic pump is restricted more when the output of the first hydraulic actuator is large than when the output of the first hydraulic actuator is small.

The hydraulic system may further include a second operating assembly to be operated to control driving of the second hydraulic actuator. The first restrictor may be configured or programmed to acquire the priority information based on an operation of the second operating assembly and change the output restriction such that the output of the first hydraulic pump is restricted more when the driving of the second hydraulic actuator is being controlled by the operation than when the driving of the second hydraulic actuator is not being controlled by the operation.

The first restrictor may be configured or programmed to, when the driving of the second hydraulic actuator is being controlled by the operation, acquire the drive state of the second hydraulic actuator and change the output restriction such that the output of the first hydraulic pump is restricted more when the output of the second hydraulic actuator is large than when the output of the second hydraulic actuator is small.

The hydraulic system may further include a manual operator to receive an operation relating to the priority information.

The first hydraulic actuator may be operable to drive a traveling device to support a machine body and cause the machine body to travel. The second hydraulic actuator may be operable to drive a working device provided on the machine body.

A working machine according to an example embodiment of the present invention includes the hydraulic system, the machine body, the traveling device, and the working device.

The working device may include a linkage to attach and detach thereto and therefrom any of a plurality of attachments. The first restrictor may be configured or programmed to change the output restriction of the first hydraulic pump in accordance with the attachment attached to the linkage.

The plurality of attachments may include a first attachment to be driven by hydraulic fluid delivered by the second hydraulic pump. The first restrictor may be configured or programmed to change the output restriction such that the output of the first hydraulic pump is restricted more when the attachment attached to the linkage is the first attachment and operable to be driven by hydraulic fluid at a high flow rate than when the attachment attached to the linkage is the first attachment and is operable to be driven by hydraulic fluid at a low flow rate.

The plurality of attachments may include a first attachment to be driven by hydraulic fluid delivered by the second hydraulic pump and a second attachment not to be driven by hydraulic fluid delivered by the second hydraulic pump. The first restrictor may be configured or programmed to change the output restriction such that the output of the first hydraulic pump is restricted more when the attachment attached to the linkage is the first attachment than when the attachment attached to the linkage is the second attachment.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a side view illustrating a track loader, which is an example of a working machine.

FIG. 2 is a configuration diagram of the working machine.

FIG. 3 illustrates a hydraulic circuit of a travel system that is included in a hydraulic system (hydraulic circuit) of the working machine.

FIG. 4 illustrates a hydraulic circuit of a work system that is included in the hydraulic system (hydraulic circuit) of the working machine.

FIG. 5 illustrates an example of a travel system line.

FIG. 6 illustrates an example of a work system line.

FIG. 7 illustrates an example of a second correction value.

FIG. 8 illustrates an example of a first correction value.

FIG. 9 illustrates an example of a third correction value.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

Example embodiments of the present invention are described below with reference to the drawings.

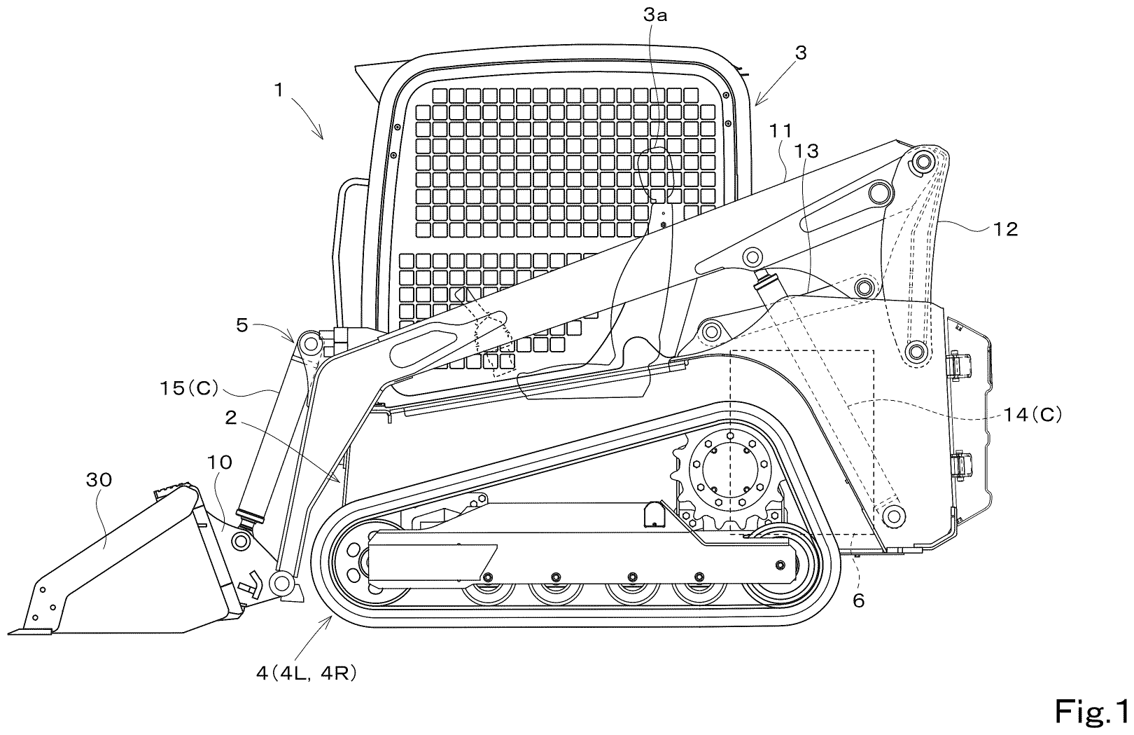

FIG. 1 is a side view illustrating a track loader, which is an example of a working machine 1. Although a compact track loader is illustrated as an example of the working machine 1 in FIG. 1, the working machines according to example embodiments of the present invention are not limited to a compact track loader and may be, for example, a loader working machine of another kind such as a skid-steer loader. The working machine 1 may be a working machine 1 other than a loader working machine.

As illustrated in FIG. 1, the working machine 1 includes a machine body 2, a cabin 3, a traveling device 4, and a working device 5. In example embodiments of the present invention, a direction (the left side in FIG. 1) which a user sitting on a seat 3a of the working machine 1 faces is referred to as a forward direction, and an opposite direction (the right side in FIG. 1) is referred to as a rearward direction. A left side (the near side in FIG. 1) from the user's point of view is referred to as a leftward direction, and a right side (the far side in FIG. 1) from the user's point of view is referred to as a rightward direction. Note that a horizontal direction orthogonal to a front-rear direction is referred to as a machine body width direction.

The machine body 2 supports various kinds of equipment of the working machine 1 such as the cabin 3 and the working device 5. For example, a prime mover 6 is mounted on the machine body 2. The prime mover 6 is a power source that generates power. The prime mover 6 is an internal-combustion engine such as a diesel engine or a gasoline engine, an electric motor, or the like.

The cabin 3 is mounted on the machine body 2. The seat 3a is provided in the cabin 3.

The traveling device 4 supports the machine body 2 and causes the machine body 2 to travel. The traveling device 4 includes a first traveling device 4L provided on the left side of the machine body 2 and a second traveling device 4R provided on the right side of the machine body 2. In the present example embodiment, the first traveling device 4L and the second traveling device 4R are crawler-type traveling devices. Note that the traveling device 4 is not limited to the crawler-type traveling device such as the one illustrated in FIG. 1, and may be a semi-crawler-type traveling device or may be a wheel-type traveling device including a front wheel and a rear wheel.

The working device 5 is provided on the machine body 2. The working device 5 includes an attachment 30, a linkage 10, a boom 11, a lift link 12, a control link 13, a boom cylinder 14, and a front cylinder 15.

The attachment 30 is, for example, a working tool such as a bucket and is attachable to and detachable from the linkage 10. Examples of the attachment 30 other than a bucket include an earth auger, an angle broom, a crusher, a grapple, a cold planer, a sweeper, a skid cutter, a skid grader, a stump grinder, a snow blower, a snow pusher, a spreader, a dozer blade, a trencher, a breaker, a pallet fork, a hopper broom, a mower, a ripper, a loader boom, and a rotary tiller.

In the following description, an attachment 30, such as an earth auger or an angle broom, that includes a hydraulic actuator (e.g., a hydraulic cylinder, a hydraulic motor) and is driven by a supplied hydraulic fluid is sometimes referred to as a “first attachment”, and an attachment 30 such as a bucket, that does not include a hydraulic actuator and is not driven by a hydraulic fluid is sometimes referred to as a “second attachment”.

The linkage 10 is a device attach and detach thereto and therefrom any of the attachments 30 and is provided on the boom 11. The linkage 10 is, for example, a quick hitch (hitch) for attachment and detachment of the attachment 30. The linkage 10 allows a user who uses the working machine 1 to easily replace the attachment 30.

The boom 11, the lift link 12, the control link 13, the boom cylinder 14, and the front cylinder 15 are provided on both left and right of the cabin 3. The left and right booms 11 are coupled by a coupling body at an intermediate portion on the front side. A hydraulic fluid output port (power output port) and a hydraulic fluid input port that are connected to the hydraulic actuator of the first attachment are provided on a front portion of the left boom 11.

The lift link 12 and the control link 13 support a base portion (rear portion) of the boom 11 with a shaft interposed therebetween so that the boom 11 is swingable up and down.

One end of the boom cylinder 14 is rotatably coupled to the boom 11 with a shaft interposed therebetween, and the other end of the boom cylinder 14 is rotatably coupled to a rear lower portion of the machine body 2 with a shaft interposed therebetween. The boom cylinder 14 raises and lowers the boom 11 by extending and contracting.

One end of the front cylinder 15 is rotatably coupled to the boom 11 with a shaft interposed therebetween, and the other end of the front cylinder 15 is rotatably coupled to the linkage 10 with a shaft interposed therebetween. The front cylinder 15 swings the attachment 30 (the linkage 10) by extending and contracting.

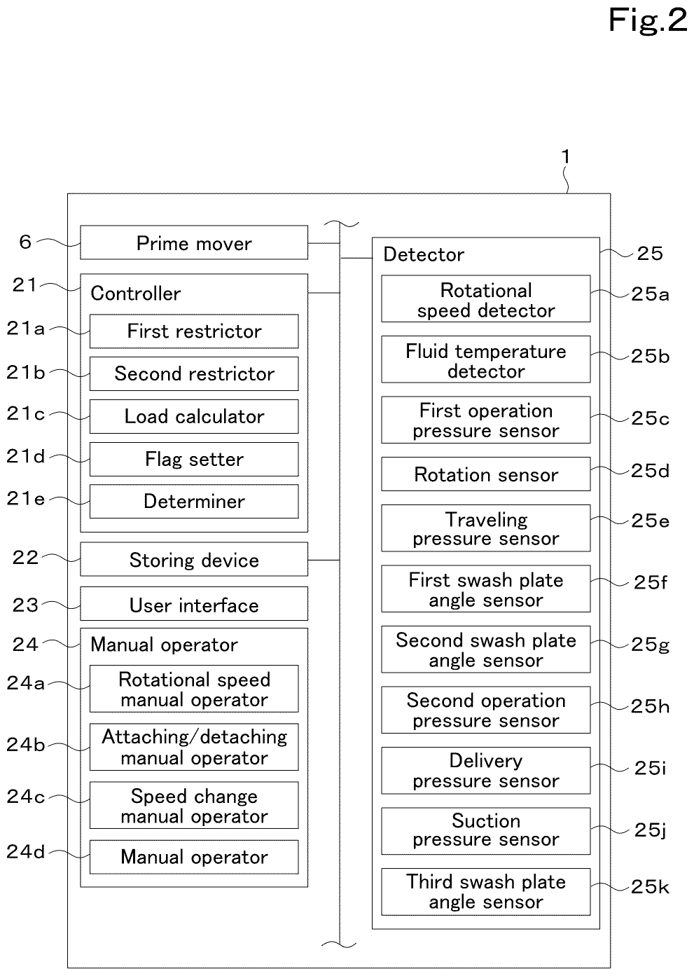

FIG. 2 is a configuration diagram of the working machine 1. The working machine 1 includes a controller 21, a storing device (memory and/or storage) 22, a user interface 23, a plurality of manual operators 24, a plurality of detectors 25, and the like.

The controller 21 may include a processing circuit including one or more processors. The controller 21 is a controller of the working machine 1 and is configured or programmed to perform various kinds of control relating to the working machine 1. The controller 21 is communicably connected to a plurality of pieces of equipment mounted on the working machine 1 over an in-vehicle network such as CAN, ISOBUS, LIN, or FlexRay.

The controller 21 includes one or more memories, various analog circuits, various digital circuits, and the like. The one or more memories store (record) therein software program(s) to be executed by the one or more processors and various data. Specifically, among the one or more memories of the controller 21, a memory (internal memory) is a volatile or nonvolatile memory. The controller 21 uses, for example, a predetermined storage region of a volatile memory as a buffer for temporary storage of information and data.

The storing device 22 (non-volatile memory) is communicably connected to the controller 21, and the storing device 22 is provided outside the controller 21. In the memory and the storing device 22, a software program and control data used by the controller 21 to control operation of each unit are stored.

The controller 21 causes the one or more processors to read out the software program and control data from the storing device 22 and perform various processes based on the software program and control data. Note that the controller 21 may cause the one or more processors to perform various processes based on a predetermined logical circuit.

Examples of the processors include a central processing unit (CPU), a graphics processing unit (GPU), a digital signal processor (DSP), a field programmable gate array (FPGA), and an application specific integrated circuit (ASIC).

Note that the controller 21 may perform various processes by cooperation of a plurality of processors that are physically separate, and the configuration thereof is not limited to the above configuration. In such a case, the plurality of processors are mounted in one or more computers that are physically separate from the working machine 1, and these processors are communicably connected over a network such as an in-vehicle network, LAN, WAN, or the Internet.

The software program may be stored in a recording medium (a nonvolatile memory such as an HDD, an SSD, a CD-ROM, or a DVD-ROM) communicably connected to the controller 21 or an external server device connected over the network and installed from the recording medium or the external server device into the memory.

The user interface 23 is, for example, a touch panel or the like. In another example, the user interface 23 may include an input device and an output device which are separate from each other.

The plurality of manual operators 24 include a pedal, a switch, a lever, a dial, and/or the like that are operated by the user who uses the working machine 1. The plurality of manual operators 24 are connected to the controller 21 and output an operation signal to the controller 21. The controller 21 is configured or programmed to control equipment included in the working machine 1 based on the operation signals output from the plurality of manual operators 24. The plurality of manual operators 24 include a rotational speed manual operator 24a to control the target rotational speed of the prime mover 6, an attaching/detaching manual operator 24b to perform the operation of attaching and detaching the attachment 30 to and from the linkage 10, and the like. The manual operator 24 is described by taking the rotational speed manual operator 24a as an example. The rotational speed manual operator 24a is an accelerator lever that is swingably supported, an accelerator pedal that is swingably supported, an accelerator volume that is rotatably supported, an accelerator slider that is slidably supported, or the like.

Note that the user interface 23 and the plurality of manual operators 24 are operably provided around the seat 3a of the cabin 3.

The plurality of detectors 25 are devices that detect states of equipment provided in the working machine 1. For example, the plurality of detectors 25 include a rotational speed detector 25a that detects an actual rotational speed of the prime mover 6 (prime mover rotational speed) and a fluid temperature detector 25b that detects a temperature of a hydraulic fluid.

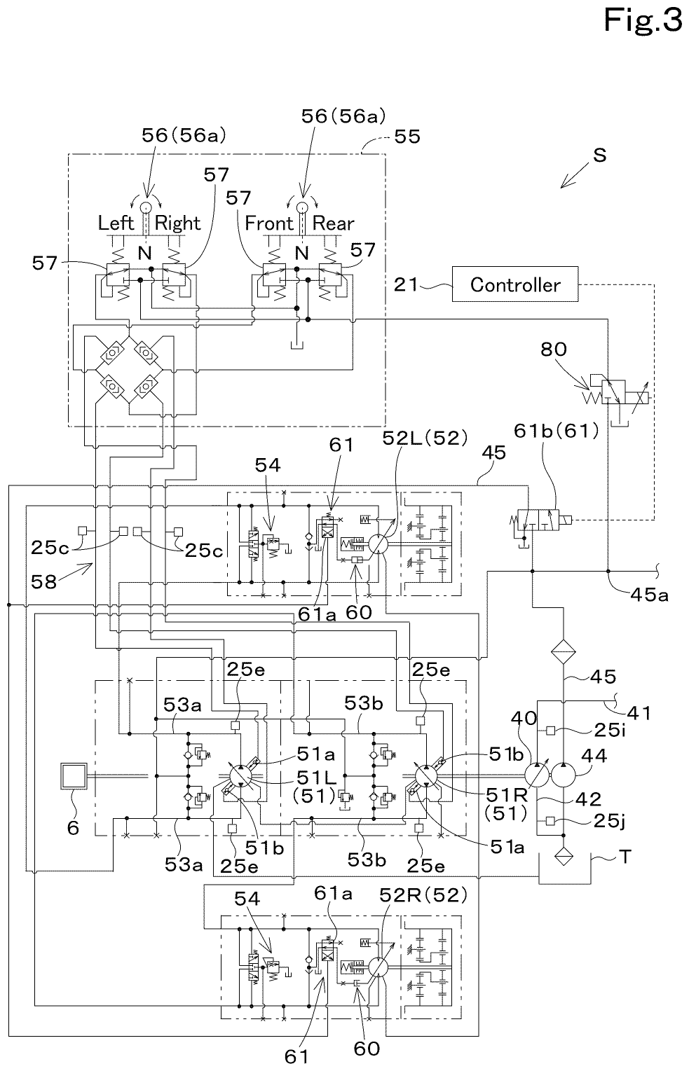

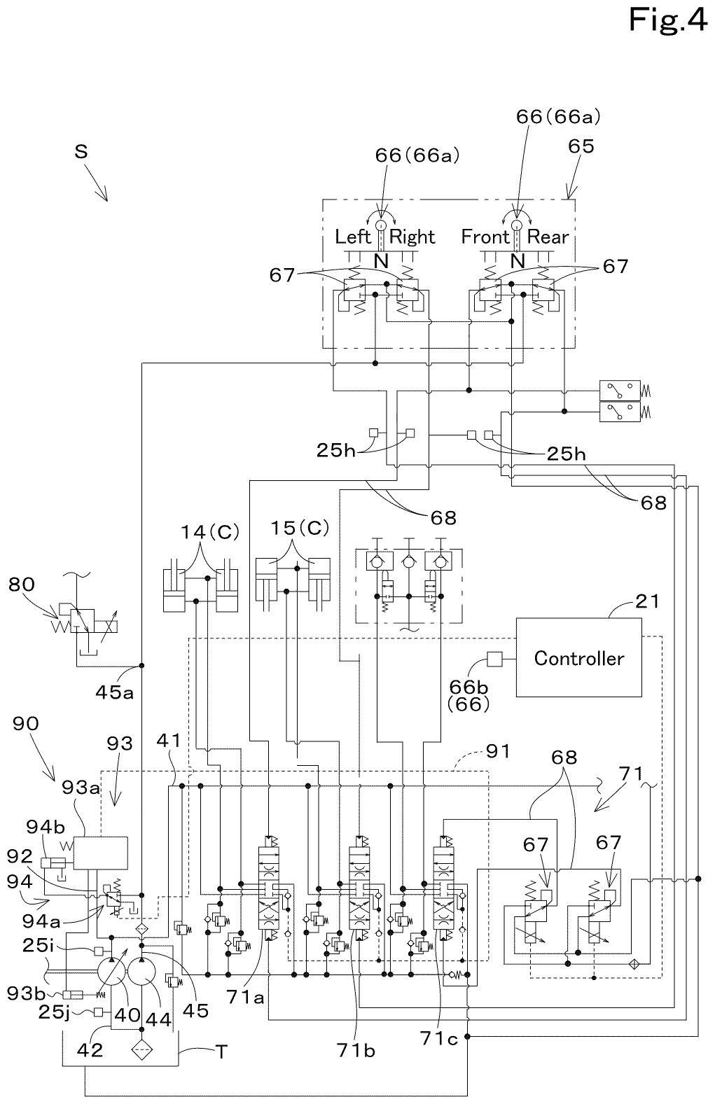

A hydraulic system S (hydraulic circuit) included in the working machine 1 is described below with reference to FIGS. 3 and 4. FIG. 3 illustrates a hydraulic circuit of a travel system that is included in the hydraulic system S of the working machine 1. FIG. 4 illustrates a hydraulic circuit of a work system that is included in the hydraulic system S of the working machine 1. The hydraulic system S of the travel system of the working machine 1 is a system to cause the traveling device 4 to operate. The hydraulic system S of the work system of the working machine 1 is a system to cause the working device 5 to operate. As illustrated in FIGS. 3 and 4, the hydraulic system S of the working machine 1 includes a main pump 40 (second hydraulic pump) and a pilot pump 44.

The main pump 40 is a variable displacement hydraulic pump (swash-plate variable displacement axial pump) to be driven by power from the prime mover 6 to deliver hydraulic fluid. The main pump 40 is connected between a main fluid passage 41 and a suction fluid passage 42 connected to the hydraulic fluid tank T, and can deliver a hydraulic fluid stored in the hydraulic fluid tank T to the main fluid passage 41. An angle of a swash plate (swash plate angle) of the main pump 40 is changed to change a delivery amount of the hydraulic fluid. In particular, the main pump 40 supplies the hydraulic fluid to the hydraulic system S of the work system.

The pilot pump 44 operates by receiving power from the prime mover 6 and delivers a hydraulic fluid. The pilot pump 44 is a fixed displacement gear pump. Specifically, the pilot pump 44 is connected between the hydraulic fluid tank T and a delivery fluid passage 45, and can deliver the hydraulic fluid stored in the hydraulic fluid tank T to the delivery fluid passage 45. In particular, the pilot pump 44 mainly delivers a hydraulic fluid used for control of the working machine 1.

In the following description, a hydraulic fluid used for control that is included in the hydraulic fluid delivered from the pilot pump 44 is sometimes referred to as a pilot oil, and a pressure of the pilot oil is sometimes referred to as a pilot pressure.

As illustrated in FIG. 3, the hydraulic circuit of the travel system includes a first hydraulic pump 51 (traveling pump) and a first hydraulic actuator 52. The traveling pump 51 is a variable displacement hydraulic pump (swash-plate variable displacement axial pump) to be driven by power from the prime mover 6 to deliver hydraulic fluid. In the present example embodiment, the traveling pump 51 includes a first traveling pump 51L and a second traveling pump 51R.

The traveling pump 51 includes a pressure receiver for forward traveling 51a and a pressure receiver for rearward traveling 51b on which the pilot pressure acts. An angle of a swash plate of the traveling pump 51 is changed in accordance with the pilot pressure that acts on the pressure receiver for forward traveling 51a and the pressure receiver for rearward traveling 51b. When the angle of the swash plate of the traveling pump 51 is changed, a delivery amount (output) of the hydraulic fluid that is supplied from the delivery fluid passage 45 and a delivery direction of the hydraulic fluid can be changed.

The first hydraulic actuator 52 is hydraulic equipment that is driven by a hydraulic fluid delivered by the traveling pump 51. The first hydraulic actuator 52 is hydraulic equipment that drives the traveling device 4, and is, for example, a motor (traveling motor 52) that operates by a hydraulic fluid delivered from the traveling pump 51 and transmits power to a drive shaft of the traveling device 4.

The traveling motor 52 can change a rotational speed (the number of rotations) to a first speed (a predetermined low speed range) on a low speed side and to a second speed (a predetermined high speed range) on a higher speed side than the first speed. When an angle of a swash plate of the traveling motor 52 is changed, the rotational speed can be changed. In the present example embodiment, the traveling motor 52 includes a first traveling motor 52L and a second traveling motor 52R.

The first traveling motor 52L is driven by a hydraulic fluid delivered from the first traveling pump 51L and transmits power to a drive shaft of the first traveling device 4L. The first traveling motor 52L is connected to the first traveling pump 51L by a circulating fluid passage 53a, and a hydraulic fluid is supplied to the first traveling motor 52L from the first traveling pump 51L through the circulating fluid passage 53a. The first traveling motor 52L can change a rotational speed (the number of rotations) based on a flow rate of the hydraulic fluid that is supplied from the first traveling pump 51L.

The second traveling motor 52R is driven by a hydraulic fluid delivered from the second traveling pump 51R and transmits power to a drive shaft of the second traveling device 4R. The second traveling motor 52R is connected to the second traveling pump 51R by a circulating fluid passage 53b, and a hydraulic fluid is supplied to the second traveling motor 52R from the second traveling pump 51R through the circulating fluid passage 53b. The second traveling motor 52R can change a rotational speed (the number of rotations) based on a flow rate of the hydraulic fluid that is supplied from the second traveling pump 51R.

As illustrated in FIG. 3, a traveling relief valve 54 is provided in the circulating fluid passages 53a and 53b. The traveling relief valve 54 discharges a hydraulic fluid flowing through the circulating fluid passages 53a and 53b to the hydraulic fluid tank T in a case where the working machine 1 performs work such as soil pushing by a bucket.

Operation relating to the travel of the working machine 1, that is, operation (traveling operation) of the traveling device 4 is described in detail below. As illustrated in FIG. 3, the hydraulic system S of the working machine 1 includes a first operating assembly 55 (travel operating assembly).

The travel operating assembly 55 is operable to control the driving of the traveling motor 52. In the present example embodiment, the travel operating assembly 55 is operable toe control the driving of the traveling motor 52 by changing a hydraulic fluid that is delivered by the traveling pump 51 in accordance with the operation. The travel operating assembly 55 can change the angle of the swash plate of the traveling pump 51 by changing the pilot pressure that acts on the pressure receivers 51a and 51b in accordance with operation. The travel operating assembly 55 includes a first manual operator 56 (travel manual operator) and a plurality of first operation valves 57 (travel operation valves).

The travel manual operator 56 includes an operating lever 56a (traveling lever) that swings in a left-right direction or a front-rear direction.

The plurality of travel operation valves 57 are valves that operate by operation of the travel manual operator 56. Specifically, the plurality of travel operation valves 57 are connected to the delivery fluid passage 45 and can change the pressure (pilot pressure) of the pilot oil, which is a hydraulic fluid that is supplied from the delivery fluid passage 45. The plurality of travel operation valves 57 support the traveling lever 56a and are operated by the traveling lever 56a. The plurality of travel operation valves 57 change an opening in accordance with an operation direction and an operation amount of the traveling lever 56a, and thus a pressure of an output pilot oil changes. The plurality of travel operation valves 57 are connected to the traveling pump 51 by a traveling fluid passage 58, and cause the pressure (pilot pressure) of the pilot oil to act on the pressure receivers 51a and 51b of the traveling pump 51 through the traveling fluid passage 58.

Although a case where the plurality of travel operation valves 57 support the traveling lever 56a and physically operate by operation of the traveling lever 56a has been described as an example in the above example, it is only necessary that the travel operating assembly 55 is operable to control the driving of the traveling motor 52 by changing a hydraulic fluid delivered by the traveling pump 51 in accordance with operation. For example, a detection sensor that detects an operation amount and an operation direction of the travel manual operator 56 (e.g., the traveling lever 56a) may be provided, and the controller 21 may electrically cause the plurality of travel operation valves 57 to operate based on a detection result of the detection sensor.

As illustrated in FIG. 3, the hydraulic system S of the working machine 1 includes a hydraulic cylinder 60 (switching cylinder) that changes the angle of the swash plate of the traveling motor 52 and a speed switching valve 61 that changes a hydraulic fluid that is supplied to the switching cylinder 60. In the present example embodiment, the speed switching valve 61 includes a first switching valve 61a and a second switching valve 61b.

The first switching valve 61a is connected to the switching cylinder 60 by a fluid passage and changes a supply amount of a hydraulic fluid that is supplied to the switching cylinder 60. The first switching valve 61a is, for example, a two-position switching valve that can be switched between a first position and a second position. The first switching valve 61a in the first position stops supply of a hydraulic fluid to the switching cylinder 60 and thus contracts the switching cylinder 60. The first switching valve 61a in the second position supplies a hydraulic fluid to the switching cylinder 60 and thus extends the switching cylinder 60.

The second switching valve 61b is connected to a pressure receiver of the first switching valve 61a by a fluid passage and changes a switch position of the first switching valve 61a by changing a pilot pressure that acts on the pressure receiver. The second switching valve 61b is a two-position switching valve that can be switched between a first position and a second position by energization. The second switching valve 61b in the first position causes the pilot oil to act on the pressure receiver of the first switching valve 61a and thus switches the first switching valve 61a to the first position. On the other hand, the second switching valve 61b in the second position does not cause the pilot oil to act on the pressure receiver of the first switching valve 61a and thus switches the first switching valve 61a to the second position.

The second switching valve 61b is operated by a speed change manual operator 24c included in the plurality of manual operators 24. Specifically, the controller 21 acquires an operation signal of the speed change manual operator 24c, outputs a control signal (e.g., a voltage, a current) to the second switching valve 61b in accordance with operation of the speed change manual operator 24c, and thus changes the switching position of the second switching valve 61b. The traveling motor 52 can thus switch between the first speed and the second speed in accordance with operation of the speed change manual operator 24c.

As illustrated in FIG. 4, the hydraulic circuit of the work system includes a control valve unit 71 and a second hydraulic actuator C. The second hydraulic actuator C is hydraulic equipment that is driven by a hydraulic fluid delivered by the main pump 40. The second hydraulic actuator C is hydraulic equipment to drive the working device 5 and is, for example, a boom cylinder 14 and a front cylinder 15 that operate by a hydraulic fluid delivered from the main pump 40. In a case where the attachment 30 attached to the linkage 10 is an attachment 30 that is driven by a hydraulic fluid, a hydraulic actuator (e.g., a hydraulic cylinder, a hydraulic motor; hereinafter referred to as a preliminary actuator) of the attachment 30 is the second hydraulic actuator C.

The control valve unit 71 causes a hydraulic fluid supplied from the main pump 40 through the main fluid passage 41 to flow to the second hydraulic actuator C. The control valve unit 71 discharges, to the hydraulic fluid tank T, a hydraulic fluid (return oil) discharged from the second hydraulic actuator C. The control valve unit 71 controls a supply direction and a supply amount of the hydraulic fluid that is supplied to the second hydraulic actuator C.

Specifically, the control valve unit 71 includes control valves 71a, 71b, and 71c corresponding to the respective second hydraulic actuators C (e.g., the boom cylinder 14, the front cylinder 15, the preliminary actuator). Each of the control valves 71a, 71b, and 71c can be switched among a neutral position, a first position, and a second position. Each of the control valves 71a, 71b, and 71c is held in the neutral position by elastic force of a spring. In the present example embodiment, a switching position of each of the control valves 71a, 71b, and 71c is changed in accordance with a pilot pressure that acts on a pressure receiver.

Operation relating to work of the working machine 1, that is, operation (work operation) of the working device 5 is described in detail below. As illustrated in FIG. 4, the hydraulic system S of the working machine 1 includes a second operating assembly 65 (work operating assembly).

The work operating assembly 65 is operable to control the driving of the second hydraulic actuator C. In the present example embodiment, the work operating assembly 65 changes a hydraulic fluid delivered by the main pump 40 by controlling the control valves 71a, 71b, and 71c in accordance with operation, and thus controls the driving of the second hydraulic actuators C. The work operating assembly 65 can change a pilot pressure that acts on the pressure receivers of the control valves 71a, 71b, and 71c in accordance with operation and thus change positions of the control valves 71a, 71b, and 71c. The work operating assembly 65 includes a second manual operator 66 (work manual operator) and a plurality of second operation valves 67 (work operation valves).

The work manual operator 66 includes an operating lever 66a (work lever) that swings in the left-right direction or the front-rear direction and an operation switch 66b (preliminary switch). The preliminary switch 66b is, for example, a seesaw-type switch that is swingable, a slide-type switch that is slidable, or a push-type switch that is pressable.

The plurality of work operation valves 67 are valves that operate by operation of the work manual operator 66. Specifically, the plurality of work operation valves 67 are connected to the delivery fluid passage 45, and can change the pressure (pilot pressure) of the pilot oil supplied from the delivery fluid passage 45. Among the plurality of work operation valves 67, the work operation valves 67 connected to the control valves 71a and 71b support the work lever 66a and are operated by the work lever 66a. These work operation valves 67 change an opening in accordance with an operation direction and an operation amount of the work lever 66a, and thus a pressure of an output pilot oil changes. The work operation valves 67 are connected to the control valves 71a and 71b by work fluid passages 68, and cause the pressure (pilot pressure) of the pilot oil to act on the pressure receivers of the control valves 71a and 71b through the work fluid passages 68.

Among the plurality of work operation valves 67, the work operation valve 67 corresponding to the control valve 71c is an electromagnetic proportional valve that is operated by the preliminary switch 66b. The controller 21 acquires an operation signal of the preliminary switch 66b, outputs a control signal to the work operation valve 67 in accordance with operation of the preliminary switch 66b, and thus changes the position of the work operation valve 67. The work operation valve 67 changes an opening in accordance with the control signal, and thus a pressure of an output pilot oil changes. The work operation valve 67 is connected to the control valve 71c by the work fluid passage 68, and causes the pressure (pilot pressure) of the pilot oil to act on the pressure receiver of the control valve 71c through the work fluid passage 68.

Although a case where the plurality of work operation valves 67 support the work lever 66a and physically operate by operation of the work lever 66a has been described as an example in the above example, it is only necessary that the work operating assembly 65 is operable to control the driving of the second hydraulic actuators C by changing the hydraulic fluid output from the control valve unit 71 in accordance with operation. For example, a detection sensor that detects an operation direction and an operation direction of the work manual operator 66 (e.g., the work lever 66a) may be provided, and the controller 21 may electrically cause the work operation valves 67 corresponding to the control valves 71a and 71b to operate based on a detection result of the detection sensor.

The hydraulic system S of the working machine 1 can prevent or reduce stalling (engine stall) of the prime mover 6 by restricting (lowering) output of the traveling pump 51 and the main pump 40 in accordance with the load on the prime mover 6. That is, the hydraulic system S of the working machine 1 according to the present example embodiment performs control (anti-stall control) of preventing or reducing engine stall by restricting horsepower consumption (torque consumption) of the prime mover 6 in both of the hydraulic system S of the travel system and the hydraulic system S of the work system. As illustrated in FIG. 2, the hydraulic system S of the working machine 1 includes a first restrictor 21a and a second restrictor 21b. Furthermore, the hydraulic system S of the working machine 1 includes a load calculator 21c.

The first restrictor 21a restricts the output of the traveling pump 51 in accordance with the load on the prime mover 6. The second restrictor 21b restricts the output of the main pump 40 in accordance with the load on the prime mover 6. That is, the first restrictor 21a performs anti-stall control (first anti-stall control) of the hydraulic system S of the travel system, and the second restrictor 21b performs anti-stall control (second anti-stall control) of the hydraulic system S of the work system. The first restrictor 21a and the second restrictor 21b are, for example, software programs installed in the controller 21.

The load calculator 21c calculates the load on the prime mover 6. The load calculator 21c calculates, as the load on the prime mover 6, a drop rotational speed, which is a difference between a target rotational speed of the prime mover 6 and an actual rotational speed of the prime mover 6. The load calculator 21c is, for example, a software program installed in the controller 21. The load calculator 21c calculates the drop rotational speed based on a difference between the target rotational speed of the prime mover 6 operated by the rotational speed manual operator 24a and the actual rotational speed of the prime mover 6 detected by the rotational speed detector 25a (the target rotational speed−the actual rotational speed). The first restrictor 21a and the second restrictor 21b perform the anti-stall control based on the load on the prime mover 6 calculated by the load calculator 21c.

The first restrictor 21a changes an output restriction of the traveling pump 51 in accordance with priority information relating to the traveling motor 52 and the second hydraulic actuators C and/or the second restrictor 21b changes an output restriction of the main pump 40 in accordance with the priority information. The following describes, as an example, a case where the first restrictor 21a does not change the output restriction of the traveling pump 51 in accordance with the priority information and the second restrictor 21b changes the output restriction of the main pump 40 in accordance with the priority information.

The priority information is information defining priorities relating to the driving of the traveling motor 52 and the second hydraulic actuators C. Specifically, the priority information includes priorities of allocation of horsepower consumed (consumption of horsepower of the prime mover 6) to drive the traveling motor 52 and the second hydraulic actuators C. The second restrictor 21b acquires, for example, priority information based on the operation of the travel operating assembly 55. The second restrictor 21b changes the output restriction based on the priority information such that the output of the main pump 40 is restricted more when the driving of the traveling motor 52 is being controlled by the operation of the travel operating assembly 55 than when the driving of the traveling motor 52 is not being controlled by the operation.

Specifically, the second restrictor 21b acquires first priority information in a case where the travel operating assembly 55 is not being operated and acquires second priority information in a case where the travel operating assembly 55 is being operated. Accordingly, the second restrictor 21b acquires, as the priority information, one of the first priority information and the second priority information and does not acquire the other one of the first priority information and the second priority information in a case where the one of the first priority information and the second priority information is acquired. The second priority information indicates a higher priority relating to the driving of the traveling motor 52 than the first priority information.

The controller 21 includes a flag setter 21d that sets a flag (first priority flag) corresponding to the priority information based on an operation of the travel operating assembly 55, and the second restrictor 21b refers to the first priority flag set by the flag setter 21d. The second restrictor 21b acquires the first priority information in a case where the first priority flag is off. The second restrictor 21b acquires the second priority information in a case where the first priority flag is on.

The flag setter 21d is, for example, a software program installed in the controller 21. The flag setter 21d acquires an operation state of the travel operating assembly 55, for example, based on the pilot pressure of the pilot oil output from the traveling operation valve 57. In such a case, a pressure sensor 25c (first operation pressure sensor) that detects the pilot pressure of the pilot oil that acts on the pressure receivers 51a and 51b is provided in the traveling fluid passage 58, and the flag setter 21d acquires the operation state of the travel operating assembly 55 based on a detection signal of the first operation pressure sensor 25c. For example, in a case where the pilot pressure detected by the first operation pressure sensor 25c is equal to or greater than a predetermined value, the flag setter 21d determines that the travel operating assembly 55 is being operated and turns the first priority flag on. On the other hand, in a case where the pilot pressure detected by the first operation pressure sensor 25c is less than the predetermined value, the flag setter 21d determines that the travel operating assembly 55 is not being operated and turns the first priority flag off.

Note that a method for acquiring the operation state of the travel operating assembly 55 is not limited to the one using the pilot pressure detected by the first operation pressure sensor 25c and may be another method, as long as the flag setter 21d sets on and off of the first priority flag based on an operation of the travel operating assembly 55. For example, in a case where a detection sensor that detects an operation amount and an operation direction of the travel manual operator 56 is provided, the operation state of the travel operating assembly 55 may be acquired based on a detection result of the detection sensor.

The first restrictor 21a and the first anti-stall control are described in detail below. As the first anti-stall control, the first restrictor 21a restricts horsepower of the prime mover 6 that is consumed by the traveling pump 51 by changing the pilot pressure (primary pressure) of the pilot oil supplied to the traveling operation valve 57 and thus lowering the output of the traveling pump 51.

As illustrated in FIG. 3, the hydraulic system S of the working machine 1 includes an actuated valve 80 that is provided on the delivery fluid passage 45 and can change the pilot pressure of the pilot oil that causes the traveling pump 51 to operate. The first restrictor 21a changes the pilot pressure (primary pressure) of the pilot oil supplied from the delivery fluid passage 45 to the travel operating assembly 55 (the plurality of travel operation valves 57) by controlling the opening of the actuated valve 80.

The actuated valve 80 is provided on the delivery fluid passage 45 between the traveling operation valve 57 and a branch point 45a branching into a fluid passage connected to the traveling operation valve 57 and a fluid passage connected to the work operation valve 67 side. The controller 21 (the first restrictor 21a) outputs a control signal (e.g., a voltage, a current) to the actuated valve 80, the actuated valve 80 operates based on the control signal and changes the opening, and thus the pilot pressure (primary pressure) of the pilot oil supplied from the delivery fluid passage 45 to the travel operating assembly 55 is changed. The following describes a case where the control signal output to the actuated valve 80 by the controller 21 is a current, and a current value output as the control signal is referred to as a “first indicated current value”. An electromagnetic proportional valve defining the actuated valve 80 can increase an opening in proportion to the first indicated current value.

That is, the primary pressure is changed in accordance with the control signal output from the first restrictor 21a to the actuated valve 80. In the present example embodiment, the first restrictor 21a outputs the first indicated current value to the actuated valve 80, and therefore the primary pressure is changed in accordance with the first indicated current value. Specifically, as the first indicated current value increases, the opening of the actuated valve 80 increases, and the primary pressure increases. On the other hand, as the first indicated current value decreases, the opening of the actuated valve 80 decreases, and the primary pressure decreases.

Accordingly, there is a proportional relation or a correspondence relation (correlation) close to a proportional relation between the first indicated current value and the primary pressure. Therefore, the first restrictor 21a can change a target pressure of the pilot pressure (primary pressure) of the pilot oil supplied to the plurality of travel operation valves 57 by changing the first indicated current value.

The first restrictor 21a defines the first indicated current value based on the actual rotational speed of the prime mover 6 detected by the rotational speed detector 25a and the drop rotational speed calculated by the load calculator 21c. The first restrictor 21a acquires a first control map stored in advance in the storing device 22 and refers to a travel system line L1 set in the first control map. The first restrictor 21a acquires the first indicated current value corresponding to the actual rotational speed on the travel system line L1 which the first restrictor 21a refers to.

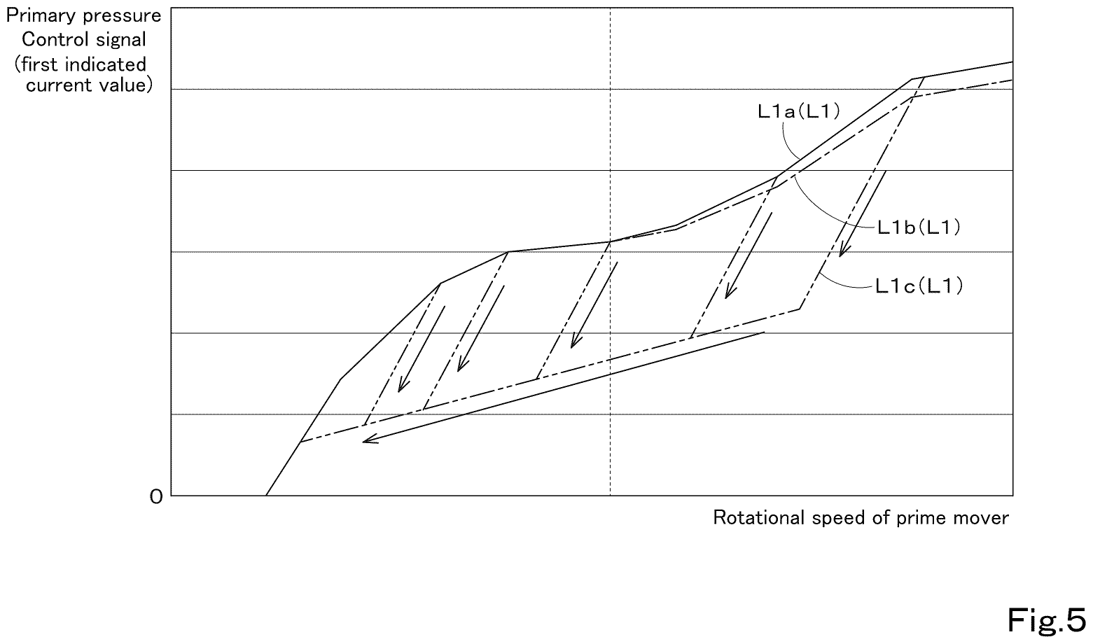

FIG. 5 illustrates an example of the travel system line L1 to set the control signal (the target pressure of the primary pressure) based on the actual rotational speed of the prime mover 6. The travel system line L1 is a function by which the first restrictor 21a defines the control signal based on the actual rotational speed of the prime mover 6. The travel system line L1 is derived based on a result of an experiment or simulation that is conducted in advance. According to the travel system line L1 illustrated in FIG. 5, the first indicated current value increases as the actual rotational speed of the prime mover 6 increases. That is, as the actual rotational speed of the prime mover 6 increases, the first indicated current value output to the actuated valve 80 by the first restrictor 21a is increased, and the primary pressure is increased, and as a result, the output of the traveling pump 51 increases. On the other hand, as the actual rotational speed of the prime mover 6 decreases, the first indicated current value output to the actuated valve 80 by the first restrictor 21a is decreased, and the primary pressure is decreased, and as a result, the output of the traveling pump 51 decreases. The example illustrated in FIG. 5 is a control map (anti-stall map) illustrating an example of the travel system line L1. The travel system line L1 includes a first travel system line L1a and a third travel system line L1c. In FIG. 5, the first travel system line L1a is indicated by the solid line, and the third travel system line L1c is indicated by the line with alternate long and two short dashes.

As described above, the first indicated current value, which is a control signal output to the actuated valve 80 by the first restrictor 21a, and the target pressure of the primary pressure are in a correspondence relation such as a proportional relation. That is, the travel system line L1 illustrated in FIG. 5 is, in other words, a line that defines the target pressure of the primary pressure corresponding to the control signal (first indicated current value) based on the actual rotational speed of the prime mover 6. In FIG. 5, the vertical axis can be regarded as the “control signal (first indicated current value)” or can be regarded as the “primary pressure (target pressure)”.

The first travel system line L1a is a line to set the control signal (the first indicated current value) corresponding to the target pressure of the primary pressure based on the actual rotational speed in a case where the load that acts on the prime mover 6 is less than a predetermined value (for example, the drop rotational speed is less than a first threshold value). That is, the first travel system line L1a is a no-load characteristic line used in a case where the load on the prime mover 6 is less than the predetermined value. Note that the first threshold value is a predetermined value and is a value stored in advance in the storing device 22 and may be changeable as appropriate by operation of the user interface 23.

The third travel system line L1c is a line to set the control signal (the first indicated current value) corresponding to the target pressure of the primary pressure based on the actual rotational speed in a case where the load that acts on the prime mover 6 is equal to or greater than the predetermined value (for example, the drop rotational speed is equal to or greater than the first threshold value). That is, the third travel system line L1c is a drop characteristic line used in a case where a traveling load equal to or greater than a predetermined value occurs.

The third travel system line L1c is a line that sets the first indicated current value that is larger than the first indicated current value of the first travel system line L1a at the same actual rotational speed. Note that the third travel system line L1c is provided corresponding to the actual rotational speed of the prime mover 6 and exists for each actual rotational speed. Accordingly, in a case where shift occurs from a state where the drop rotational speed is less than the first threshold value to a state where the drop rotational speed is equal to or greater than the first threshold value, the first restrictor 21a refers to the third travel system line L1c passing the first indicated current value that is being output to the actuated valve 80 and the actual rotational speed.

The second restrictor 21b and the second anti-stall control are described in detail below. In the second anti-stall control, the second restrictor 21b restricts the output of the main pump 40 in accordance with a drive state of the second hydraulic actuator C in addition to the load on the prime mover 6. Note that as described above, the first restrictor 21a restricts the output of the traveling pump 51 in accordance with the load on the prime mover 6 irrespective of a drive state of the traveling motor 52 in the first anti-stall control, unlike the second restrictor 21b. As the second anti-stall control, the second restrictor 21b restricts horsepower of the prime mover 6 that is consumed by the main pump 40 by changing the angle of the swash plate of the main pump 40 and thus lowering the output of the main pump 40. Specifically, the second restrictor 21b controls the main pump 40 to control the pressure difference between the delivery pressure of the main pump 40 and the maximum load pressure during actuation of the second hydraulic actuator C at a predetermined pressure difference (set pressure) based on the load on the prime mover 6.

As illustrated in FIG. 4, the hydraulic system S of the working machine 1 includes a load sensing system 90 that controls the pressure difference between the delivery pressure of the main pump 40 and the maximum load pressure during operation of the second hydraulic actuator C to the set pressure, and the second restrictor 21b restricts the output of the main pump 40 by controlling the set pressure. The load sensing system 90 includes a PLS fluid passage 91, a PPS fluid passage 92, a hydraulic pressure controller 93, and a setting changer 94.

The PLS fluid passage 91 is connected to the control valves 71a, 71b, and 71c. The PLS fluid passage 91 is a fluid passage for detection of load pressures, which are pressures of the hydraulic fluid applied to the control valves 71a, 71b, and 71c during operation of the control valves 71a, 71b, and 71c. On the PLS fluid passage 91, a PLS signal pressure, which is a maximum load pressure among the load pressures of the control valves 71a, 71b, and 71c, can act. That is, on the PLS fluid passage 91, a maximum load pressure during operation of the second hydraulic actuators C can act.

The PPS fluid passage 92 is connected to a delivery port of the main pump 40. On the PPS fluid passage 92, a PPS signal pressure, which is a pressure (delivery pressure) of the hydraulic fluid delivered from the main pump 40, can act. That is, a delivery pressure of the hydraulic fluid from the main pump 40 can act on the PPS fluid passage 92.

The hydraulic pressure controller 93 includes a flow rate compensation valve 93a and a swash plate changer 93b. The flow rate compensation valve 93a controls operation of the swash plate changer 93b based on the PLS signal pressure and the PPS signal pressure. The flow rate compensation valve 93a is a control valve connected to the PLS fluid passage 91 and the PPS fluid passage 92. The flow rate compensation valve 93a controls operation of the swash plate changer 93b by changing the opening and thus changing the hydraulic fluid supplied to the swash plate changer 93b. The flow rate compensation valve 93a is biased toward a predetermined direction by an elastic force of a spring, and changes the opening so that a pressure difference (also referred to as a differential pressure or an LS differential pressure) between the PPS signal pressure and the PLS signal pressure becomes a set pressure.

The swash plate changer 93b changes the angle of the swash plate of the main pump 40. The swash plate changer 93b is, for example, a hydraulic cylinder. The swash plate changer 93b is connected to the swash plate of the main pump 40, and can change the angle of the swash plate of the main pump 40 by extending and contracting in accordance with the hydraulic fluid supplied from the flow rate compensation valve 93a.

The setting changer 94 can change the set pressure. The setting changer 94 includes a solenoid valve 94a and a hydraulic cylinder (changing cylinder 94b). The solenoid valve 94a is an electromagnetic proportional valve that controls the changing cylinder 94b. The solenoid valve 94a is connected to the delivery fluid passage 45. Specifically, the solenoid valve 94a is connected at least to a fluid passage of the delivery fluid passage 45 that branches from between the branch point 45a and the pilot pump 44. In the following description, a pressure of a hydraulic fluid supplied from the solenoid valve 94a to the changing cylinder 94b is sometimes referred to as a “changing pressure”.

The changing cylinder 94b acts on the flow rate compensation valve 93a, and changes the set pressure by changing the opening of the flow rate compensation valve 93a. The changing cylinder 94b is connected to the flow rate compensation valve 93a, and moves the flow rate compensation valve 93a against the elastic force of the spring by extending or contracting in accordance with the pressure (changing pressure) of the hydraulic fluid supplied from the solenoid valve 94a. In this way, the set pressure of the flow rate compensation valve 93a is changed, and a flow rate and a pressure of the hydraulic fluid supplied from the flow rate compensation valve 93a to the swash plate changer 93b are changed. In response to the change, the swash plate changer 93b extends or contracts, and thus the angle of the swash plate of the main pump 40 is changed. In the present example embodiment, as the changing pressure increases, the changing cylinder 94b extends, and the angle of the swash plate of the main pump 40 is changed so that the set pressure decreases. On the other hand, as the changing pressure decreases, the changing cylinder 94b contracts, and the angle of the swash plate of the main pump 40 is changed so that the set pressure increases.

The controller 21 (the second restrictor 21b) outputs a control signal (e.g., a voltage, a current) to the solenoid valve 94a, and the solenoid valve 94a operates based on the control signal and changes the changing pressure by changing the opening. The following describes a case where the control signal output to the solenoid valve 94a by the controller 21 is a current, and a current value output as the control signal is hereinafter referred to as a “second indicated current value”. An electromagnetic proportional valve that constitutes the solenoid valve 94a can increase the opening in proportion to the second indicated current value.

That is, the changing pressure is changed in accordance with the control signal output from the second restrictor 21b to the solenoid valve 94a. In the present example embodiment, the second restrictor 21b outputs the second indicated current value to the solenoid valve 94a, and therefore the changing pressure is changed in accordance with the second indicated current value. Specifically, as the second indicated current value increases, the opening of the solenoid valve 94a increases, and the changing pressure increases. On the other hand, as the second indicated current value decreases, the opening of the solenoid valve 94a decreases, and the changing pressure decreases.

Accordingly, there is a proportional relation or a correspondence relation (correlation) close to a proportional relation between the second indicated current value and the changing pressure. Therefore, by changing the second indicated current value that is output to the solenoid valve 94a, the second restrictor 21b can change the set pressure and restrict the output of the main pump 40.

The second restrictor 21b defines the second indicated current value based on the actual rotational speed of the prime mover 6 detected by the rotational speed detector 25a and the drop rotational speed calculated by the load calculator 21c. The second restrictor 21b acquires a second control map stored in advance in the storing device 22 and refers to a work system line L2 set in the second control map. The second restrictor 21b acquires the second indicated current value corresponding to the actual rotational speed on the work system line L2.

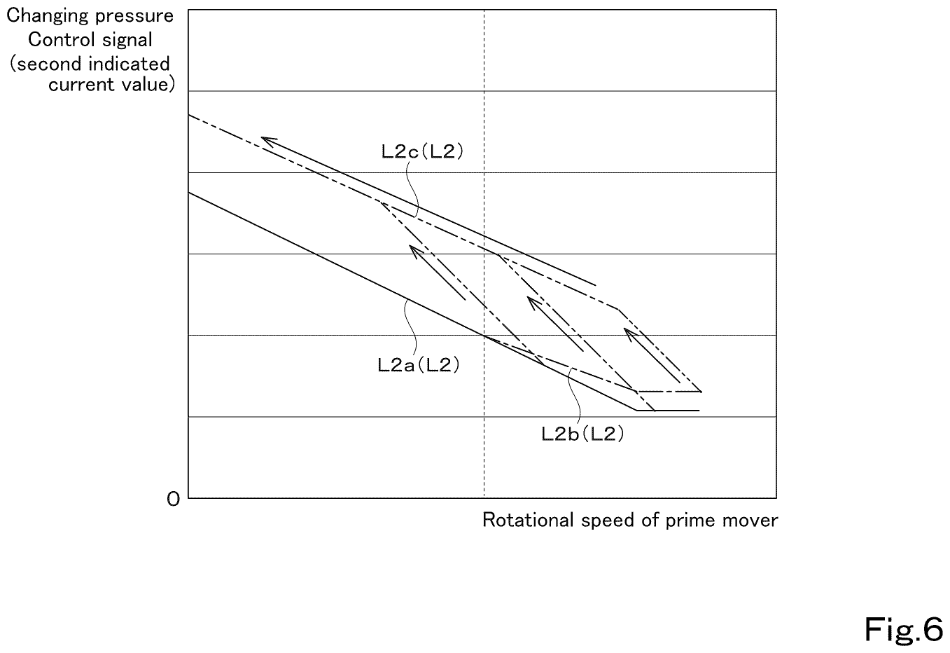

FIG. 6 illustrates an example of the work system line L2 to set the second control signal (the target pressure of the changing pressure) based on the actual rotational speed of the prime mover 6. The work system line L2 is a function by which the second restrictor 21b defines the control signal based on the actual rotational speed of the prime mover 6. The work system line L2 is derived based on a result of an experiment or simulation that is conducted in advance. The example illustrated in FIG. 6 is a control map (anti-stall map) illustrating an example of the work system line L2. According to the work system line L2 illustrated in FIG. 6, the second indicated current value decreases as the actual rotational speed of the prime mover 6 increases. That is, as the actual rotational speed of the prime mover 6 increases, the second restrictor 21b decreases the second indicated current value that is output to the solenoid valve 94a and increases the set pressure, and as a result, the output of the main pump 40 increases. On the other hand, as the actual rotational speed of the prime mover 6 decreases, the second restrictor 21b increases the second indicated current value that is output to the solenoid valve 94a and decreases the set pressure, and as a result, the output of the main pump 40 decreases. The work system line L2 includes a first work system line L2a, a second work system line L2b, and a third work system line L2c. In FIG. 6, the first work system line L2a is indicated by the solid line, the second work system line L2b is indicated by the line with alternate long and short dashes, and the third work system line L2c is indicated by the line with alternate long and two short dashes.

As described above, the second indicated current value, which is a control signal output to the solenoid valve 94a by the second restrictor 21b, and the target pressure of the changing pressure are in a correspondence relation such as a proportional relation. That is, the work system line L2 illustrated in FIG. 6 is, in other words, a line that defines the target pressure of the changing pressure corresponding to the control signal (the second indicated current value) based on the actual rotational speed of the prime mover 6. Therefore, in FIG. 6, the vertical axis can be regarded as the “control signal (second indicated current value)” or can be regarded as the “changing pressure (target pressure)”.

The first work system line L2a is a line to set the control signal (the second indicated current value) corresponding to the target pressure of the changing pressure based on the actual rotational speed in a case where the load that acts on the prime mover 6 is less than a predetermined value (for example, the drop rotational speed is less than a second threshold value). In particular, the second restrictor 21b refers to the first work system line L2a in a case where the load that acts on the prime mover 6 is less than the predetermined value and the first priority information is acquired. That is, the first work system line L2a is a no-load characteristic line used in a case where the load on the prime mover 6 is less than the predetermined value and the travel operating assembly 55 is not being operated. Note that the second threshold value is, for example, a predetermined value identical to the first threshold value and is a value stored in advance in the storing device 22 and may be changeable as appropriate by operation of the user interface 23.

The second work system line L2b is a line to set the control signal (the second indicated current value) corresponding to the target pressure of the changing pressure based on the actual rotational speed in a case where the load that acts on the prime mover 6 is less than the predetermined value (for example, the drop rotational speed is less than the second threshold value). In particular, the second restrictor 21b refers to the second work system line L2b in a case where the load that acts on the prime mover 6 is less than the predetermined value and the second priority information is acquired. That is, the second work system line L2b is a no-load characteristic line used in a case where the load on the prime mover 6 is less than the predetermined value and the travel operating assembly 55 is being operated.

The second work system line L2b is a line that can set the second indicated current value that is equal to or greater than the second indicated current value of the first work system line L2a at the same actual rotational speed. As illustrated in FIG. 6, the second work system line L2b matches the first work system line L2a in a range of the actual rotational speed less than a predetermined value (e.g., idling rotational speed), and the second work system line L2b is larger in the second indicated current value than the first work system line L2a in a range of the actual rotational speed equal to or greater than the predetermined value. Accordingly, in a case where the drop rotational speed is less than the second threshold value and the actual rotational speed is equal to or greater than the predetermined value, the second indicated current value corresponding to the same actual rotational speed is larger and the second restrictor 21b restricts the output of the main pump 40 more in a case where the second priority information is acquired than in a case where the first priority information is acquired.

Although the second work system line L2b matches the first work system line L2a in the range of the actual rotational speed less than the idling rotational speed in the example illustrated in FIG. 6, the predetermined value is not limited to the idling rotational speed, as long as the second work system line L2b can set the second indicated current value equal to or greater than the second indicated current value of the first work system line L2a. The predetermined value may be zero, and the second work system line L2b may be larger in the second indicated current value than the first work system line L2a in a range of the actual rotational speed equal to or greater than zero.

The third work system line L2c is a line to set the control signal (the second indicated current value) corresponding to the target pressure of the changing pressure based on the actual rotational speed in a case where the load that acts on the prime mover 6 is equal to or larger than the predetermined value (for example, the drop rotational speed is equal to or larger than the second threshold value). That is, the third work system line L2c is a drop characteristic line used in a case where a traveling load equal to or greater than a predetermined value occurs. The second restrictor 21b acquires the second indicated current value corresponding to the actual rotational speed on the third work system line L2c by referring to the third work system line L2c in a case where the drop rotational speed is equal to or larger than the predetermined value.

The third work system line L2c is a line to set the second indicated current value that is larger than the second indicated current value of the first work system line L2a and the second indicated current value of the second work system line L2b at the same actual rotational speed. The third work system line L2c is provided corresponding to the actual rotational speed of the prime mover 6 and exists for each actual rotational speed.

Accordingly, in a case where shift occurs from a state where the drop rotational speed is less than the second threshold value to a state where the drop rotational speed is equal to or larger than the second threshold value, the second restrictor 21b refers to the third work system line L2c that crosses the first work system line L2a or the second work system line L2b referred to by the second restrictor 21b at a current actual rotational speed. In other words, the second restrictor 21b refers to the third work system line L2c that passes the second indicated current value that is being output to the solenoid valve 94a and the actual rotational speed. That is, since the second work system line L2b can set the second indicated current value that is equal to or larger than the second indicated current value of the first work system line L2a at the same actual rotational speed, the third work system line L2c referred to by the second restrictor 21b that acquires the second priority information can set the second indicated current value that is equal to or larger than the second indicated current value set by the third work system line L2c referred to in a case where the first priority information is acquired.

Accordingly, even in a case where the drop rotational speed is equal to or larger than the second threshold value, the second restrictor 21b can restrict the output of the main pump 40 more when the second priority information is acquired than when the first priority information is acquired. Therefore, the second restrictor 21b restricts the output of the main pump 40 more when the travel operating assembly 55 is being operated than when the travel operating assembly 55 is not being operated.

The second restrictor 21b may be configured or programmed to, when the driving of the traveling motor 52 is being controlled by the operation of the travel operating assembly 55, acquire the drive state of the traveling motor 52 and change the output restriction such that the output of the main pump 40 is restricted more when the output of the traveling motor 52 is large than when the output of the traveling motor 52 is small. The second restrictor 21b changes the output restriction of the main pump 40 by correcting the second indicated current value acquired from the work system line L2 which the second restrictor 21b refers to by a correction value (second correction value) defined in accordance with the output of the traveling motor 52 and changing the set pressure.

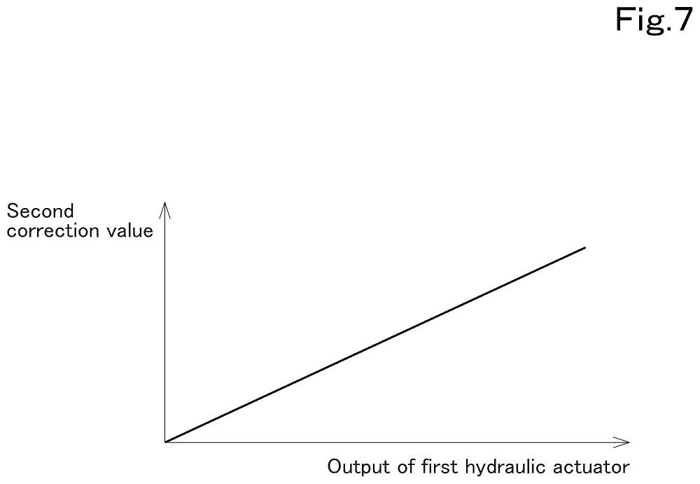

The second correction value is defined corresponding to the output of the traveling motor 52. In the present example embodiment, the second restrictor 21b corrects the second indicated current value by multiplying the second indicated current value by the second correction value. In other words, the second correction value is a correction coefficient (gain) for use in correcting the second indicated current value. FIG. 7 illustrates an example of the second correction value. As illustrated in FIG. 7, there is, for example, a proportional relation or a correspondence relation (correlation) close to a proportional relation between the second correction value and the output of the traveling motor 52. Note that the second correction value is not limited to the example illustrated in FIG. 7, as long as the second correction value is defined so that the output of the main pump 40 is restricted more in a case where the output of the traveling motor 52 is large than in a case where the output of the traveling motor 52 is small.

The second restrictor 21b acquires the output of the traveling motor 52 based on detection results of the plurality of detectors 25 provided in the working machine 1, and the second correction value corresponds to the output of the traveling motor 52. For example, the second restrictor 21b acquires, as the output of the traveling motor 52, the actual rotational speed (actual motor rotational speed) of the traveling motor 52. In such a case, the second restrictor 21b acquires the actual motor rotational speed based on a detection result of a rotation sensor 25d that is included in the plurality of detectors 25 and detects the actual motor rotational speed.

The rotation sensor 25d is connected to the controller 21 and outputs a detected signal (detection signal) to the controller 21. In the present example embodiment, the traveling motor 52 includes the first traveling motor 52L and the second traveling motor 52R, and therefore the rotation sensor 25d is attached to each of the first traveling motor 52L and the second traveling motor 52R.

In the present example embodiment, the second restrictor 21b calculates the actual rotational speed of the traveling motor 52 without distinguishing a rotational speed during normal rotation and a rotational speed during reverse rotation, and uses, as the actual rotational speed of the traveling motor 52, a sum of an actual motor rotational speed n1 of the first traveling motor 52L and an actual motor rotational speed n1 of the second traveling motor 52R. The second correction value is defined corresponding to the actual motor rotational speed used as the output of the traveling motor 52, and is defined so as to increase as the actual motor rotational speed increases.

Note that the actual motor rotational speed used as the output of the traveling motor 52 by the second restrictor 21b is not limited to the sum of the actual motor rotational speed n1 of the first traveling motor 52L and the actual motor rotational speed n1 of the second traveling motor 52R, and a higher one of the rotational speeds n1 may be used as the actual rotational speed of the traveling motor 52.

Although a case where the second restrictor 21b acquires the actual motor rotational speed as the output of the traveling motor 52 and the second correction value is defined corresponding to the actual motor rotational speed has been described in the above example, the second restrictor 21b may acquire information other than the actual motor rotational speed as the output of the traveling motor 52 and correct the second indicated current value by the second correction value based on the acquired information. For example, the second restrictor 21b may acquire an effective pressure P1 of the traveling pump 51 and use the effective pressure P1 as the output of the traveling motor 52.

As illustrated in FIG. 3, a pair of pressure sensors 25e (traveling pressure sensors) that detect either a delivery pressure P1o or a suction pressure P1i of the hydraulic fluid delivered by the traveling pump 51 are provided on the circulating fluid passages 53a and 53b. The second restrictor 21b calculates the effective pressure P1 based on a difference (P1o−P1i) between the delivery pressure P1o of the traveling pump 51 and the suction pressure P1i of the traveling pump 51. Note that the suction pressure P1i may be ignored, for example, in a case where the suction pressure P1i is substantially zero.

The second restrictor 21b may acquire a traveling speed (vehicle speed) of the working machine 1 and use the vehicle speed as the output of the traveling motor 52. Specifically, the second restrictor 21b acquires a vehicle speed that is calculated based on a detection result of the rotation sensor 25d by the controller 21. In a case where the plurality of detectors 25 include a position detector that detects a current position (machine body position) of the working machine 1 by a satellite positioning system or the like, the controller 21 may calculate the vehicle speed based on the machine body position detected by the position detector instead of the rotation sensor 25d, and the second restrictor 21b may acquire the vehicle speed.

The second restrictor 21b may acquire horsepower consumption of the traveling pump 51 and use the horsepower consumption as the output of the traveling motor 52. In the present example embodiment, the traveling pump 51 includes the first traveling pump 51L and the second traveling pump 51R, and therefore the second restrictor 21b uses, as the horsepower consumption of the traveling pump 51, the sum of horsepower consumption of the first traveling pump 51L and horsepower consumption of the second traveling pump 51R.

The second restrictor 21b calculates horsepower consumption H1 based on the delivery pressure P1o of the hydraulic fluid delivered by each traveling pump 51 and a flow rate Q1 of the hydraulic fluid. Specifically, the second restrictor 21b can calculate the horsepower consumption H1 by the following equation (1) based on the effective pressure P1 of each traveling pump 51 based on the delivery pressure P1o, the flow rate Q1 of the hydraulic fluid, and efficiency η1.

$$Horsepower consumption H 1 = ( effective pressure P 1 \times flow rate Q 1 ) / ( 60 \times η1 ) \qquad equation ( 1 )$$

Note that the efficiency η1 is a predetermined value including loss in power transmission from the prime mover 6 to each traveling pump 51 and is stored in advance in the storing device 22.

The second restrictor 21b can calculate the flow rate Q1 of the hydraulic fluid delivered by each traveling pump 51 by the following equation (2) based on a displacement volume q1 of each traveling motor 52 and the actual motor rotational speed n1 of each traveling motor 52.

$$Flow rate Q 1 = displacement volume q 1 \times actual motor rotational speed n 1 / 1000 \qquad equation ( 2 )$$

In the present example embodiment, the angle of the swash plate of the traveling motor 52 is changed by the switching cylinder 60 and the speed switching valve 61, and the traveling motor 52 is thus switched between the first speed and the second speed, and therefore the second restrictor 21b calculates the displacement volume q1 based on an operation information of the speed change manual operator 24c (information relating to switching to the first speed or the second speed) and a predetermined table stored in advance in the storing device 22. In the table, each speed and the displacement volume q1 are associated.

A method for calculating the displacement volume q1 is not limited to the above example, and the second restrictor 21b may calculate the displacement volume q1 of each traveling motor 52 based on the angle of the swash plate of the traveling motor 52. In such a case, each traveling motor 52 is provided with an angle sensor 25f (first swash plate angle sensor) that detects (measures) the angle of the swash plate of the traveling motor 52, and the second restrictor 21b calculates the displacement volume q1 based on a detection result of the first swash plate angle sensor 25f and a predetermined function or the like stored in advance in the storing device 22.

Although a case where the second restrictor 21b calculates the flow rate Q1 of the hydraulic fluid delivered by each traveling pump 51 based on the actual motor rotational speed n1 has been described in the above example, the second restrictor 21b may calculate the flow rate Q1 based on an actual rotational speed n2 (first input actual rotational speed) of power input from the prime mover 6 to the traveling pump 51 instead of the actual motor rotational speed n1. In such a case, the second restrictor 21b can calculate the flow rate Q1 of the hydraulic fluid delivered by each traveling pump 51 by the following equation (3) based on a displacement volume q2 and the first input actual rotational speed n2 of the traveling pump 51.

$$Flow rate Q 1 = displacement volume q 2 \times first input actual rotational speed n 2 / 1000 \qquad equation ( 3 )$$

In the present example embodiment, the second restrictor 21b calculates the displacement volume q2 of each traveling pump 51 based on the angle of the swash plate of the traveling pump 51. Each traveling pump 51 is provided with an angle sensor 25g (second swash plate angle sensor) that detects (measures) the angle of the swash plate of the traveling pump 51, and the second restrictor 21b calculates the displacement volume q2 based on a detection result of the second swash plate angle sensor 25g and a predetermined function or the like stored in advance in the storing device 22. The second restrictor 21b calculates the first input actual rotational speed n2 based on the actual rotational speed of the prime mover 6 detected by the rotational speed detector 25a and a predetermined function or the like stored in advance in the storing device 22.

Although a case where the second restrictor 21b acquires the horsepower consumption of the traveling pump 51 as the output of the traveling motor 52 has been described, the second restrictor 21b may acquire a consumption torque as the output of the traveling motor 52 instead of the horsepower consumption. The second restrictor 21b calculates horsepower consumption of each traveling pump 51 by a calculation method such as the one described above, and calculates the consumption torque of each traveling pump 51 by dividing the horsepower consumption by the first input actual rotational speed n2 or the like based on a predetermined function or the like stored in advance in the storing device 22. The second restrictor 21b acquires a sum of the calculated consumption torque of the traveling pumps 51 as the output of the traveling motor 52.

Although a case where the second restrictor 21b corrects the second indicated current value by multiplying the second indicated current value by the second correction value has been described as an example in the above example, a method for correcting the second indicated current value by using the second correction value is not limited to multiplication, and the second indicated current value may be corrected by division, addition, or subtraction of the second correction value from the second indicated current value depending on how the second correction value is defined, and the correction method is not limited to the above method. Furthermore, the second restrictor 21b may correct the second indicated current value by using not the second correction value, but a predetermined function.

Next, a case where the first restrictor 21a changes the output restriction of the traveling pump 51 in accordance with priority information is described as an example. In a case where the first restrictor 21a changes the output restriction of the traveling pump 51 in accordance with the priority information, the second restrictor 21b may perform output restriction of the main pump 40 in accordance with the priority information or may omit the output restriction. In a case where the output restriction of the main pump 40 is not performed in accordance with the priority information, the second restrictor 21b does not acquire the priority information, and acquires the first work system line L2a in a case where the load that acts on the prime mover 6 is less than the predetermined value.

In a case where the first restrictor 21a changes the output restriction of the traveling pump 51 in accordance with the priority information, the first restrictor 21a acquires the priority information based on an operation of the work operating assembly 65. The first restrictor 21a changes the output restriction based on the priority information such that the output of the traveling pump 51 is restricted more when the driving of the second hydraulic actuator C is being controlled by the operation than when the driving of the second hydraulic actuator C is not being controlled by the operation.

Specifically, the first restrictor 21a acquires third priority information in a case where the work operating assembly 65 is not being operated and acquires fourth priority information in a case where the work operating assembly 65 is being operated. Accordingly, the first restrictor 21a acquires one of the third priority information and the fourth priority information as the priority information and does not acquire the other one of the third priority information and the fourth priority information in a case where the one of the third priority information and the fourth priority information is acquired. The fourth priority information indicates a higher priority relating the driving of the second hydraulic actuator C than the third priority information.

The first restrictor 21a refers to a second priority flag set by the flag setter 21d and acquires the third priority information in a case where the second priority flag is off. The first restrictor 21a acquires the fourth priority information in a case where the second priority flag is on.

The flag setter 21d acquires an operation state of the work lever 66a included in the work operating assembly 65, for example, based on the pilot pressure of the pilot oil output from the work operation valve 67. In such a case, a pressure sensor 25h (second operation pressure sensor) that detects the pilot pressure of the pilot oil flowing through the work fluid passage 68 is provided in the work fluid passage 68, and the flag setter 21d acquires the operation state of the work operating assembly 65 based on a detection signal of the second operation pressure sensor 25h. For example, the flag setter 21d determines that the work lever 66a is being operated in a case where the pilot pressure detected by the second operation pressure sensor 25h is equal to or greater than a predetermined value, and determines that the work lever 66a is not being operated in a case where the pilot pressure detected by the second operation pressure sensor 25h is less than the predetermined value.

Furthermore, the flag setter 21d acquires an operation state of the preliminary switch 66b included in the work operating assembly 65 based on an operation signal of the preliminary switch 66b. Accordingly, the flag setter 21d turns the second priority flag on in a case where it is determined that at least one of the work lever 66a and the preliminary switch 66b is being operated, and turns the second priority flag off in a case where none of the work lever 66a and the preliminary switch 66b is being operated.

The flag setter 21d only needs to set on and off of the second priority flag based on an operation of the work operating assembly 65, and a method for acquiring the operation state of the work operating assembly 65 is not limited to the above example, and the operation state of the work operating assembly 65 may be acquired by another method. For example, in a case where a detection sensor that detects an operation amount and an operation direction of the work lever 66a is provided, the operation state of the work lever 66a may be acquired based on a detection result of the detection sensor.

The first restrictor 21a that changes the output restriction of the traveling pump 51 in accordance with the priority information acquires the travel system line L1 that varies depending on the priority information in a case where the load that acts on the prime mover 6 is less than a predetermined value. Specifically, in a case where the load that acts on the prime mover 6 is less than a predetermined value, the first restrictor 21a refers to the first travel system line L1a in a case where the third priority information is acquired and refers to a second travel system line L1b included in the travel system line L1 in a case where the fourth priority information is acquired.

The second travel system line L1b is a line to set the control signal (first indicated current value) corresponding to the target pressure of the primary pressure based on the actual rotational speed in a case where the load that acts on the prime mover 6 is less than the predetermined value (the drop rotational speed is less than the first threshold value). In such a case, the first travel system line L1a is a no-load characteristic line used in a case where the load on the prime mover 6 is less than the predetermined value and the work operating assembly 65 is not being operated, and the second travel system line L1b is a no-load characteristic line used in a case where the load on the prime mover 6 is less than the predetermined value and the work operating assembly 65 is being operated.

The second travel system line L1b is a line that can set the first indicated current value that is equal to or less than the first indicated current value of the first travel system line L1a at the same actual rotational speed. In FIG. 5, the second travel system line L1b is indicated by the line with alternate long and short dashes. As illustrated in FIG. 5, the second travel system line L1b matches the first travel system line L1a in a range of the actual rotational speed less than a predetermined value (e.g., idling rotational speed), and is smaller in the first indicated current value than the first travel system line L1a in a range of the actual rotational speed equal to or larger than the predetermined value. Accordingly, in a case where the drop rotational speed is less than the predetermined value, the first restrictor 21a can make the first indicated current value corresponding to the same actual rotational speed smaller and restrict the output of the traveling pump 51 more in a case where the fourth priority information is acquired than in a case where the third priority information is acquired.

Although the second travel system line L1b matches the first travel system line L1a in the range of the actual rotational speed less than the idling rotational speed in the example illustrated in FIG. 5, the predetermined value is not limited to the idling rotational speed, as long as the second travel system line L1b can set the first indicated current value that is equal to or less than the first indicated current value of the first travel system line L1a. The predetermined value may be zero, and the second travel system line L1b may be smaller in the first indicated current value than the first travel system line L1a in a range of the actual rotational speed equal to or larger than zero.

Accordingly, in a case where shift occurs from a state where the drop rotational speed is less than the first threshold value to a state where the drop rotational speed is equal to or larger than the first threshold value, the first restrictor 21a refers to the third travel system line L1c that crosses the first travel system line L1a or the second travel system line L1b referred to by the first restrictor 21a at a current actual rotational speed. In other words, the first restrictor 21a refers to the third travel system line L1c passing the first indicated current value that is being output to the actuated valve 80 and the actual rotational speed. That is, since the second travel system line L1b can set the first indicated current value that is equal to or less than the first indicated current value of the first travel system line L1a at the same actual rotational speed, the third travel system line L1c referred to by the first restrictor 21a that acquires the fourth priority information can set the first indicated current value that is equal to or less than the first indicated current value set by the third travel system line L1c referred to in a case where the third priority information is acquired.

Accordingly, even in a case where the drop rotational speed is equal to or larger than the first threshold value, the first restrictor 21a can restrict the output of the traveling pump 51 more in a case where the fourth priority information is acquired than in a case where the third priority information is acquired. Therefore, the first restrictor 21a restricts the output of the traveling pump 51 more in a case where the work operating assembly 65 is being operated than in a case where the work operating assembly 65 is not being operated.

The first restrictor 21a may be configured or programmed to, when the driving of the second hydraulic actuator C is being controlled by the operation of the work operating assembly 65, acquire a drive state of the second hydraulic actuator C and change the output restriction such that the output of the traveling pump 51 is restricted more when the output of the second hydraulic actuator C is large than when the output of the second hydraulic actuator C is small. The first restrictor 21a changes the output restriction of the traveling pump 51 by correcting the first indicated current value acquired from the travel system line L1 which the first restrictor 21a refers to by a correction value (first correction value) defined in accordance with the output of the second hydraulic actuator C and changing the primary pressure.

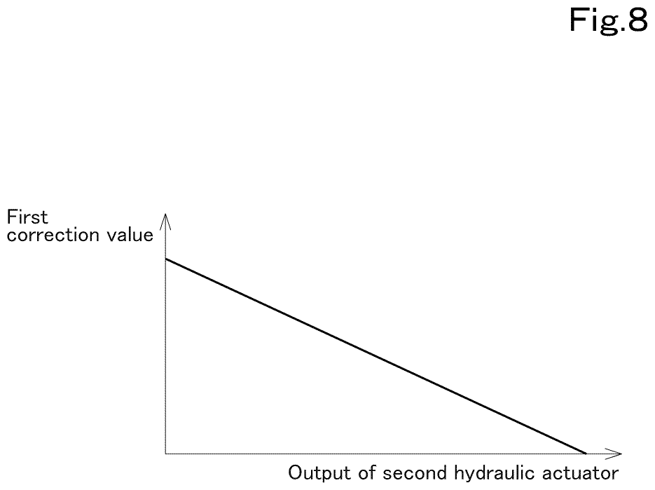

The first correction value is defined corresponding to the output of the second hydraulic actuator C. In the present example embodiment, the first restrictor 21a corrects the first indicated current value by multiplying the first indicated current value by the first correction value. In other words, the first correction value is a correction coefficient (gain) for use in correcting the first indicated current value. FIG. 8 illustrates an example of the first correction value. As illustrated in FIG. 8, there is, for example, a proportional relation or a correspondence relation (correlation) close to a proportional relation between the first correction value and the output of the second hydraulic actuator C. Note that the first correction value is not limited to the example illustrated in FIG. 8, as long as the first correction value is defined so that the output of the traveling pump 51 is restricted more in a case where the output of the second hydraulic actuator C is large than in a case where the output of the second hydraulic actuator C is small.

The first restrictor 21a acquires the output of the second hydraulic actuator C based on detection results of the plurality of detectors 25 provided in the working machine 1, and the first correction value corresponds to the output of the second hydraulic actuator C. For example, the first restrictor 21a may acquire an effective pressure P2 of the main pump 40 and use the effective pressure P2 as the output of the second hydraulic actuator C.

As illustrated in FIG. 3, a pressure sensor 25i (delivery pressure sensor) that detects a delivery pressure P2o of the hydraulic fluid that is delivered by the main pump 40 is provided in the main fluid passage 41, and a pressure sensor 25j (suction pressure sensor) that detects a suction pressure P2i of the hydraulic fluid that is sucked by the main pump 40 is provided in the suction fluid passage 42. The first restrictor 21a calculates the effective pressure P2 based on a difference (P2o−P2i) between the delivery pressure P2o and the suction pressure P2i. Note that the suction pressure P2i may be ignored, for example, in a case where the suction pressure P2i is substantially zero. In such a case, the suction pressure sensor 25j need not be provided in the main fluid passage 41 and the suction fluid passage 42.

The first restrictor 21a may acquire horsepower consumption of the main pump 40 and use the horsepower consumption as the output of the second hydraulic actuator C. The first restrictor 21a calculates horsepower consumption H2 based on the delivery pressure P2o of the hydraulic fluid that is delivered by the main pump 40 and a flow rate Q2 of the hydraulic fluid. Specifically, the first restrictor 21a can calculate the horsepower consumption H2 by the following equation (4) based on the effective pressure P2 of the main pump 40 based on the delivery pressure P2o, the flow rate Q2 of the hydraulic fluid, and efficiency n2.

$$Horsepower consumption H 2 = ( effective pressure P 2 \times flow rate Q 2 ) / ( 60 \times η2 ) \qquad equation ( 4 )$$

Note that the efficiency n2 is a predetermined value including loss in power transmission from the prime mover 6 to the main pump 40 and is stored in advance in the storing device 22.

The first restrictor 21a can calculate the flow rate Q2 of the hydraulic fluid that is delivered by the main pump 40 by the following equation (5) based on an actual rotational speed n3 (second input actual rotational speed) of power input from the prime mover 6 to the main pump 40.

$$Flow rate Q 2 = displacement volume q \text{} \text{} 3 \times second input actual rotational speed n 3 / 1000 \qquad equation ( 5 )$$

In the present example embodiment, the first restrictor 21a calculates the displacement volume q3 of each main pump 40 based on the angle of the swash plate of the main pump 40. The main pump 40 is provided with an angle sensor 25k (third swash plate angle sensor) that detects (measures) the angle of the swash plate of the main pump 40, and the first restrictor 21a calculates the displacement volume q3 based on a detection result of the third swash plate angle sensor 25k and a predetermined function or the like stored in advance in the storing device 22. The first restrictor 21a calculates the second input actual rotational speed n3 based on the actual rotational speed of the prime mover 6 detected by the rotational speed detector 25a and a predetermined function or the like stored in advance in the storing device 22.

Although a case where the first restrictor 21a acquires the horsepower consumption of the main pump 40 as the output of the second hydraulic actuator C has been described, the first restrictor 21a may acquire consumption torque as the output of the second hydraulic actuator C instead of the horsepower consumption. The first restrictor 21a calculates the horsepower consumption of the main pump 40 by a method such as the one described above, and calculates the consumption torque of the main pump 40 by dividing the horsepower consumption by the second input actual rotational speed n3 or the like based on a predetermined function or the like stored in advance in the storing device 22. The first restrictor 21a acquires a sum of the calculated consumption torque of the main pump 40 as the output of the second hydraulic actuator C.

Although a case where the first restrictor 21a corrects the first indicated current value by multiplying the first indicated current value by the first correction value has been described as an example in the above example, a method for correcting the first indicated current value by using the first correction value is not limited to multiplication, and the first indicated current value may be corrected by division, addition, or subtraction of the first correction value from the first indicated current value depending on how the first correction value is defined, and the correction method is not limited to the above method. Furthermore, the first restrictor 21a may correct the first indicated current value by using not the first correction value but a predetermined function.

Although a case where the flag setter 21d sets a flag corresponding to priority information based on an operation of the travel operating assembly 55 and operation of the work operating assembly 65 and the first restrictor 21a and the second restrictor 21b acquire the priority information based on the flag has been described as an example in the above example, the priority information need not correspond to operation of the travel operating assembly 55 and operation of the work operating assembly 65. For example, the user may be able to manually operate the priority information by operating a manual operator 24d. In the present example embodiment, the manual operator 24d is an operation switch included in the plurality of manual operators 24 and receives an operation of selecting the priority information.

In a case where both of the first restrictor 21a and the second restrictor 21b change the output restriction based on the priority information, the manual operator 24d receives an operation of selecting among the first to fourth priority information. For example, the manual operator 24d receives an operation of selecting a “traveling priority mode” in which the second priority information and the third priority information are selected and priority is given to drive of the traveling motor 52, a “neutral mode” in which the first priority information and the third priority information are selected and priority is given to none of drive of the traveling motor 52 and drive of the second hydraulic actuator C, and a “work priority mode” in which the first priority information and the fourth priority information are selected and priority is given to drive of the second hydraulic actuator C.

Note that in a case where the second restrictor 21b changes the output restriction based on the priority information and the first restrictor 21a does not change the output restriction based on the priority information, the manual operator 24d receives an operation of selecting the first priority information or the second priority information. In such a case, the manual operator 24d receives an operation of selecting a “traveling priority mode” in which the second priority information is selected and priority is given to drive of the traveling motor 52 and a “neutral mode” in which the first priority information is selected and priority is not given to drive of the traveling motor 52.

In a case where the first restrictor 21a changes the output restriction based on the priority information and the second restrictor 21b does not change the output restriction based on the priority information, the manual operator 24d receives an operation of selecting the third priority information or the fourth priority information. In such a case, the manual operator 24d receives an operation of selecting a “neutral mode” in which the third priority information is selected and priority is not given to drive of the second hydraulic actuator C and a “work priority mode” in which the fourth priority information is selected and priority is given to drive of the second hydraulic actuator C.

The flag setter 21d acquires an operation signal of the manual operator 24d and sets a flag in accordance with operation of the manual operator 24d. The flag setter 21d turns on a flag corresponding to priority information selected by the manual operator 24d and turns off a flag corresponding to priority information that is not selected.

Furthermore, the flag setter 21d may set the first priority flag, for example, based on change of a speed stage (the first speed, the second speed) of the traveling motor 52 irrespective of operation of the travel operating assembly 55. For example, the flag setter 21d acquires operation information of the speed change manual operator 24c, and turns off the first priority flag in a case where the speed stage of the traveling motor 52 is changed to the first speed and turns on the first priority flag in a case where the speed stage of the traveling motor 52 is changed to the second speed.

The first restrictor 21a may change the output restriction of the traveling pump 51 in accordance with the attachment 30 attached to the linkage 10. For example, the first restrictor 21a changes the output restriction so such that the output of the traveling pump 51 is restricted more when the attachment 30 attached to the linkage 10 is the first attachment and operable to be driven by hydraulic fluid at a high flow rate (consumed flow rate) than when the attachment 30 attached to the linkage 10 is the first attachment and is operable to be driven at low consumed flow rate. Accordingly, the first restrictor 21a changes the output restriction such that the output of the traveling pump 51 is restricted more when the attachment 30 attached to the linkage 10 is the first attachment than when the attachment 30 attached to the linkage 10 is the second attachment. The first restrictor 21a changes the output restriction of the traveling pump 51 by correcting the first indicated current value acquired from the travel system line L1 which the first restrictor 21a refers to by a correction value (third correction value) defined in accordance with the attached attachment 30 and changing the primary pressure.

Specifically, the hydraulic system S of the working machine 1 includes a determiner 21e configured or programmed to determine the attachment 30 attached to the linkage 10, and the first restrictor 21a changes the output restriction based on the attachment 30 specified by the determiner 21e. The determiner 21e is, for example, a software program installed in the controller 21. The determiner 21e determines the attachment 30 attached to the linkage 10 based on information input by the user interface 23. That is, the determiner 21e determines the attachment 30 based on user's manual operation of selecting the attachment 30. When the attachment 30 is attached to the linkage 10, the user interface 23 displays an attachment list including a plurality of pieces of attachment-30 information indicative of a plurality of attachments 30 attachable to the linkage 10, and the determiner 21e determines the attachment 30 attached to the linkage 10 from a piece of attachment-30 information selected from the attachment list by the user interface 23.

The storing device 22 stores therein a correspondence between identification information (attachment ID) of the attachment 30 and the third correction value in a table format. The attachment ID of the attachment 30 and the third correction value are stored in a predetermined storage region of the storing device 22 in association with each other. Note that control data such as a hydraulic pressure level or a hydraulic fluid output to the attachment 30 other than the third correction value may be stored in the storing device 22 in association with the attachment ID.

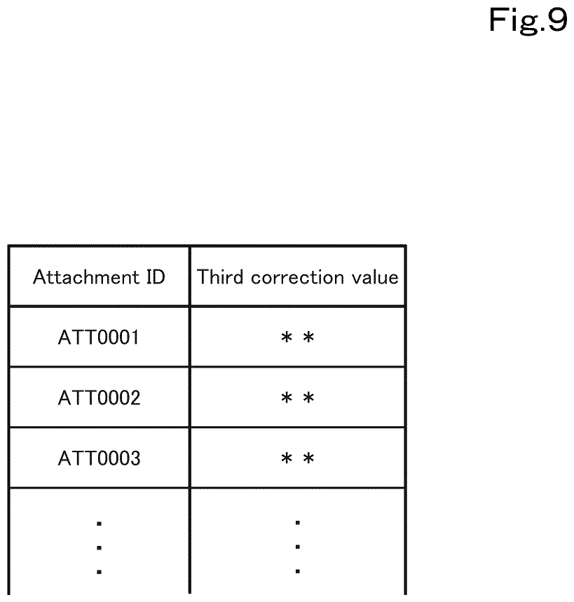

The third correction value is defined corresponding to the attachment 30. In the present example embodiment, the first restrictor 21a corrects the first indicated current value by multiplying the first indicated current value by the third correction value. In other words, the third correction value is a correction coefficient (gain) for use in correcting the first indicated current value. FIG. 9 illustrates an example of the third correction value. The third correction value is defined in accordance with consumed flow rate of a hydraulic fluid required for drive by each actuator and is defined so that the value of the first attachment that is large in consumed flow rate is larger than the value of the first attachment that is small in consumed flow rate.

In the present example embodiment, the third correction value corresponding to the second attachment that does not include a hydraulic actuator and is not driven by a hydraulic fluid is “1”, and the first restrictor 21a does not substantially correct the first indicated current value. Although a case where the third correction value is defined corresponding to an actuator is described in the above example, it is only necessary that the first restrictor 21a change the output restriction of the traveling pump 51 based on the attached attachment 30. For example, the third correction value may be defined corresponding to a type or work contents of the attachment 30.

Although a case where the user manually selects the attached attachment 30 by operating the user interface 23 has been described as an example in the above example, the determiner 21e may automatically determine the attached attachment 30. For example, in a case where a transmitter (beacon) that periodically transmits a radio signal including an attachment ID is provided on the attachment 30 and the working machine 1 includes a receiver that receives the radio signal transmitted from the beacon, the determiner 21e automatically determines the attached attachment 30 based on the radio signal.

Although a case where the first restrictor 21a corrects the first indicated current value by multiplying the first indicated current value by the third correction value has been described as an example in the above example, a method for correcting the first indicated current value by using the third correction value is not limited to multiplication, and the first indicated current value may be corrected by division, addition, or subtraction of the first correction value from the first indicated current value depending on how the third correction value is defined, and the correction method is not limited to the above method. Furthermore, the first restrictor 21a may correct the first indicated current value by using not the third correction value but a predetermined function.

Example embodiments of the present invention provide hydraulic systems S for working machines 1 and working machines 1 described in the following items.

(Item 1) A hydraulic system S for a working machine 1, the hydraulic system S including a prime mover 6, a variable displacement first hydraulic pump 51 to be driven by power from the prime mover 6 to deliver hydraulic fluid, a first hydraulic actuator 52 to be driven by hydraulic fluid delivered by the first hydraulic pump 51, a variable displacement second hydraulic pump 40 to be driven by power from the prime mover 6 to deliver hydraulic fluid, the second hydraulic pump 40 being different from the first hydraulic pump 51, a second hydraulic actuator C to be driven by hydraulic fluid delivered by the second hydraulic pump 40, a first restrictor 21a configured or programmed to restrict an output of the first hydraulic pump 51 in accordance with a load on the prime mover 6, and a second restrictor 21b configured or programmed to restrict an output of the second hydraulic pump 40 in accordance with the load on the prime mover 6, wherein the first restrictor 21a is configured or programmed to change an output restriction of the first hydraulic pump 51 in accordance with priority information relating to the first hydraulic actuator 52 and the second hydraulic actuator C and/or the second restrictor 21b is configured or programmed to change an output restriction of the second hydraulic pump 40 in accordance with the priority information.

With the hydraulic system S for a working machine 1 according to item 1, it is possible to properly balance, based on the priority information, the output restriction of the first hydraulic pump 51 and the output restriction of the second hydraulic pump 40 based on the load on the prime mover 6.

(Item 2) The hydraulic system S according to item 1, wherein the first restrictor 21a is configured or programmed to restrict the output of the first hydraulic pump 51 in accordance with the load on the prime mover 6 irrespective of a drive state of the first hydraulic actuator 52, and the second restrictor 21b is configured or programmed to restrict the output of the second hydraulic pump 40 in accordance with a drive state of the second hydraulic actuator C in addition to the load on the prime mover 6.

With the hydraulic system S for a working machine 1 according to item 2, the first restrictor 21a and the second restrictor 21b restrict the output of the hydraulic pumps based on different conditions, whereas the second restrictor 21b properly balances the output of the second hydraulic pump 40 in accordance with the priority information. Accordingly, the hydraulic system S for a working machine 1 makes it possible to improve the working performance of the first hydraulic actuator 52 or the second hydraulic actuator C in accordance with the priority information while eliminating or reducing the likelihood that the prime mover 6 will stall.

(Item 3) The hydraulic system S according to item 2, wherein the first restrictor 21a is configured or programmed to restrict the output of the first hydraulic pump 51 in accordance with a drop rotational speed which is a difference between a target rotational speed of the prime mover 6 and an actual rotational speed of the prime mover 6.

With the hydraulic system S for a working machine 1 according to item 3, the drop rotational speed is used as the load on the prime mover 6, and therefore the first restrictor 21a can perform the output restriction of the first hydraulic pump 51 by relatively simple arithmetic processing.

(Item 4) The hydraulic system S according to item 2 or 3, wherein the second restrictor 21b is configured or programmed to control the second hydraulic pump 40 to control a pressure difference between a delivery pressure of the second hydraulic pump 40 and a maximum load pressure during actuation of the second hydraulic actuator C at a predetermined pressure difference based on the load on the prime mover 6.

With the hydraulic system S for a working machine 1 according to item 4, it is possible to appropriately control the horsepower of the second hydraulic pump 40 in consideration of the drive state of the second hydraulic actuator C.

(Item 5) The hydraulic system S according to any one of items 2 to 4, further including a first operating assembly 55 to be operated to control driving of the first hydraulic actuator 52, wherein the second restrictor 21b is configured or programmed to acquire the priority information based on an operation of the first operating assembly 55 and change the output restriction such that the output of the second hydraulic pump 40 is restricted more when the driving of the first hydraulic actuator 52 is being controlled by the operation than when the driving of the first hydraulic actuator 52 is not being controlled by the operation.

With the hydraulic system S for a working machine 1 according to item 5, it is possible to appropriately define the priority information based on the operation of the first operating assembly 55, i.e., based on the user's intention to drive the first hydraulic actuator 52. That is, the second restrictor 21b makes it possible to have the user's intention instantly reflected in the output restriction without the need for an operation other than the operation of the first operating assembly 55.

(Item 6) The hydraulic system S according to item 5, wherein the second restrictor 21b is configured or programmed to, when the driving of the first hydraulic actuator 52 is being controlled by the operation, acquire the drive state of the first hydraulic actuator 52 and change the output restriction such that the output of the second hydraulic pump 40 is restricted more when the output of the first hydraulic actuator 52 is large than when the output of the first hydraulic actuator 52 is small.

With the hydraulic system S for a working machine 1 according to item 6, the second restrictor 21b can more properly perform the output restriction in accordance with the output of the first hydraulic actuator 52.

(Item 7) The hydraulic system S according to any one of items 2 to 6, further including a second operating assembly 65 to be operated to control driving of the second hydraulic actuator C, wherein the first restrictor 21a is configured or programmed to acquire the priority information based on an operation of the second operating assembly 65 and change the output restriction such that the output of the first hydraulic pump 51 is restricted more when the driving of the second hydraulic actuator C is being controlled by the operation than when the driving of the second hydraulic actuator C is not being controlled by the operation.

With the hydraulic system S for a working machine 1 according to item 7, it is possible to appropriately define the priority information based on the operation of the second operating assembly 65, i.e., a user's intention to drive the second hydraulic actuator C. That is, the first restrictor 21a can have the user's intention instantly reflected in the output restriction without the need for an operation other than the operation of the second operating assembly 65.

(Item 8) The hydraulic system S according to item 7, wherein the first restrictor 21a is configured or programmed to, when the driving of the second hydraulic actuator C is being controlled by the operation, acquire the drive state of the second hydraulic actuator C and change the output restriction such that the output of the first hydraulic pump 51 is restricted more when the output of the second hydraulic actuator C is large than when the output of the second hydraulic actuator C is small.

With the hydraulic system S for a working machine 1 according to item 8, the first restrictor 21a can more properly perform the output restriction in accordance with the output of the second hydraulic actuator C.

(Item 9) The hydraulic system S according to any one of items 2 to 4, further including a manual operator 24d to receive an operation relating to the priority information.

With the hydraulic system S for a working machine 1 according to item 9, the priority information is not frequently changed unless the manual operator 24d is operated. It is therefore possible to eliminate or reduce the likelihood that the priority information will frequently fluctuate (change) while the user is operating the working machine 1.

(Item 10) The hydraulic system S according to any one of items 1 to 9, wherein the first hydraulic actuator 52 is operable to drive a traveling device 4 to support a machine body 2 and cause the machine body 2 to travel, and the second hydraulic actuator C is operable to drive a working device 5 provided on the machine body 2.

With the hydraulic system S for a working machine 1 according to item 10, it is possible to properly change the output balance between the driving of the travel system and the driving of the work system while eliminating or reducing the likelihood that the prime mover 6 will stall.

(Item 11) A working machine 1 including the hydraulic system S according to any one of items 1 to 10, the machine body 2, the traveling device 4, and the working device 5.

With the working machine 1 according to item 11, it is possible to provide a working machine 1 that achieves the above-described specific effect(s).

(Item 12) The working machine 1 according to item 11, wherein the working device 5 includes a linkage 10 to attach and detach thereto and therefrom any of a plurality of attachments 30, and the first restrictor 21a is configured or programmed to change the output restriction of the first hydraulic pump 51 in accordance with the attachment 30 attached to the linkage 10.

With the working machine 1 according to item 12, it is possible to change the output restriction of the first hydraulic pump 51 by the first restrictor 21a in consideration of the content of work done by the attachment 30, and therefore possible to eliminate or reduce the likelihood that the prime mover 6 will stall while improving the working performance of the attachment 30.

(Item 13) The working machine 1 according to item 12, wherein the plurality of attachments 30 include a first attachment to be driven by hydraulic fluid delivered by the second hydraulic pump 40, and the first restrictor 21a is configured or programmed to change the output restriction such that the output of the first hydraulic pump 51 is restricted more when the attachment 30 attached to the linkage 10 is the first attachment and operable to be driven by hydraulic fluid at a high flow rate than when the attachment 30 attached to the linkage 10 is the first attachment and is operable to be driven by hydraulic fluid at a low flow rate.

With the working machine 1 according to item 13, the output of the first hydraulic pump 51 is restricted in accordance with the flow rate of hydraulic fluid for work to be done by the attachment 30, making it possible to improve the working performance of the attachment 30 while eliminating or reducing the likelihood that the prime mover 6 will stall.

(Item 14) The working machine 1 according to item 12, wherein the plurality of attachments 30 include a first attachment to be driven by hydraulic fluid delivered by the second hydraulic pump 40 and a second attachment not to be driven by hydraulic fluid delivered by the second hydraulic pump 40, and the first restrictor 21a is configured or programmed to change the output restriction such that the output of the first hydraulic pump 51 is restricted more when the attachment 30 attached to the linkage 10 is the first attachment than when the attachment 30 attached to the linkage 10 is the second attachment.

With the working machine 1 according to item 14, the output restriction of the first hydraulic pump 51 is changed in accordance with the configuration of the attachment 30, making it possible to improve operability in a case where the attachment 30 is the first attachment. It is therefore possible to properly balance the driving of the working device 5 and the driving of the traveling device 4 while eliminating or reducing the likelihood that the prime mover 6 will stall.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A hydraulic system for a working machine, the hydraulic system comprising:
a prime mover;
a variable displacement first hydraulic pump to be driven by power from the prime mover to deliver hydraulic fluid;
a first hydraulic actuator to be driven by hydraulic fluid delivered by the first hydraulic pump;
a variable displacement second hydraulic pump to be driven by power from the prime mover to deliver hydraulic fluid, the second hydraulic pump being different from the first hydraulic pump;
a second hydraulic actuator to be driven by hydraulic fluid delivered by the second hydraulic pump;
a first restrictor configured or programmed to restrict an output of the first hydraulic pump in accordance with a load on the prime mover; and
a second restrictor configured or programmed to restrict an output of the second hydraulic pump in accordance with the load on the prime mover; wherein
the first restrictor is configured or programmed to change an output restriction of the first hydraulic pump in accordance with priority information relating to the first hydraulic actuator and the second hydraulic actuator and/or the second restrictor is configured or programmed to change an output restriction of the second hydraulic pump in accordance with the priority information.

2. The hydraulic system according to claim 1, wherein
the first restrictor is configured or programmed to restrict the output of the first hydraulic pump in accordance with the load on the prime mover irrespective of a drive state of the first hydraulic actuator; and
the second restrictor is configured or programmed to restrict the output of the second hydraulic pump in accordance with a drive state of the second hydraulic actuator in addition to the load on the prime mover.

3. The hydraulic system according to claim 2, wherein
the first restrictor is configured or programmed to restrict the output of the first hydraulic pump in accordance with a drop rotational speed which is a difference between a target rotational speed of the prime mover and an actual rotational speed of the prime mover.

4. The hydraulic system according to claim 2, wherein
the second restrictor is configured or programmed to control the second hydraulic pump to control a pressure difference between a delivery pressure of the second hydraulic pump and a maximum load pressure during actuation of the second hydraulic actuator at a predetermined pressure difference based on the load on the prime mover.

5. The hydraulic system according to claim 3, wherein
the second restrictor is configured or programmed to control the second hydraulic pump to control a pressure difference between a delivery pressure of the second hydraulic pump and a maximum load pressure during actuation of the second hydraulic actuator at a predetermined pressure difference based on the load on the prime mover.

6. The hydraulic system according to claim 2, further comprising a first operating assembly to be operated to control driving of the first hydraulic actuator; wherein
the second restrictor is configured or programmed to acquire the priority information based on an operation of the first operating assembly and change the output restriction such that the output of the second hydraulic pump is restricted more when the driving of the first hydraulic actuator is being controlled by the operation than when the driving of the first hydraulic actuator is not being controlled by the operation.

7. The hydraulic system according to claim 3, further comprising a first operating assembly to be operated to control driving of the first hydraulic actuator; wherein
the second restrictor is configured or programmed to acquire the priority information based on an operation of the first operating assembly and change the output restriction such that the output of the second hydraulic pump is restricted more when the driving of the first hydraulic actuator is being controlled by the operation than when the driving of the first hydraulic actuator is not being controlled by the operation.

8. The hydraulic system according to claim 4, further comprising a first operating assembly to be operated to control driving of the first hydraulic actuator; wherein
the second restrictor is configured or programmed to acquire the priority information based on an operation of the first operating assembly and change the output restriction such that the output of the second hydraulic pump is restricted more when the driving of the first hydraulic actuator is being controlled by the operation than when the driving of the first hydraulic actuator is not being controlled by the operation.

9. The hydraulic system according to claim 5, further comprising a first operating assembly to be operated to control driving of the first hydraulic actuator wherein
the second restrictor is configured or programmed to acquire the priority information based on an operation of the first operating assembly and change the output restriction such that the output of the second hydraulic pump is restricted more when the driving of the first hydraulic actuator is being controlled by the operation than when the driving of the first hydraulic actuator is not being controlled by the operation.

10. The hydraulic system according to claim 6, wherein
the second restrictor is configured or programmed to, when the driving of the first hydraulic actuator is being controlled by the operation, acquire the drive state of the first hydraulic actuator and change the output restriction such that the output of the second hydraulic pump is restricted more when the output of the first hydraulic actuator is large than when the output of the first hydraulic actuator is small.

11. The hydraulic system according to claim 7, wherein
the second restrictor is configured or programmed to, when the driving of the first hydraulic actuator is being controlled by the operation, the acquire the drive state of the first hydraulic actuator and change the output restriction such that the output of the second hydraulic pump is restricted more when the output of the first hydraulic actuator is large than when the output of the first hydraulic actuator is small.

12. The hydraulic system according to claim 8, wherein
the second restrictor is configured or programmed to, when the driving of the first hydraulic actuator is being controlled by the operation, acquire the drive state of the first hydraulic actuator and change the output restriction such that the output of the second hydraulic pump is restricted more when the output of the first hydraulic actuator is large than when the output of the first hydraulic actuator is small.

13. The hydraulic system according to claim 2, further comprising a second operating assembly to be operated to control driving of the second hydraulic actuator; wherein
the first restrictor is configured or programmed to acquire the priority information based on an operation of the second operating assembly and change the output restriction such that the output of the first hydraulic pump is restricted more when the driving of the second hydraulic actuator is being controlled by the operation than when the driving of the second hydraulic actuator is not being controlled by the operation.

14. The hydraulic system according to claim 13, wherein
the first restrictor is configured or programmed to, when the driving of the second hydraulic actuator is being controlled by the operation, acquire the drive state of the second hydraulic actuator and change the output restriction such that the output of the first hydraulic pump is restricted more when the output of the second hydraulic actuator is large than when the output of the second hydraulic actuator is small.

15. The hydraulic system according to claim 2, further comprising a manual operator to receive an operation relating to the priority information.

16. The hydraulic system according to claim 1, wherein
the first hydraulic actuator is operable to drive a traveling device to support a machine body and cause the machine body to travel; and
the second hydraulic actuator is operable to drive a working device provided on the machine body.

17. A working machine comprising:
the hydraulic system according to claim 16;
the machine body;
the traveling device; and
the working device.

18. The working machine according to claim 17, wherein
the working device includes a linkage to attach and detach thereto and therefrom any of a plurality of attachments; and
the first restrictor is configured or programmed to change the output restriction of the first hydraulic pump in accordance with the attachment attached to the linkage.

19. The working machine according to claim 18, wherein
the plurality of attachments include a first attachment to be driven by hydraulic fluid delivered by the second hydraulic pump; and
the first restrictor is configured or programmed to change the output restriction such that the output of the first hydraulic pump is restricted more when the attachment attached to the linkage is the first attachment and operable to be driven by hydraulic fluid at a high flow rate than when the attachment attached to the linkage is the first attachment and is operable to be driven by hydraulic fluid at a low flow rate.

20. The working machine according to claim 18, wherein
the plurality of attachments include a first attachment to be driven by hydraulic fluid delivered by the second hydraulic pump and a second attachment not to be driven by hydraulic fluid delivered by the second hydraulic pump; and
the first restrictor is configured or programmed to change the output restriction such that the output of the first hydraulic pump is restricted more when the attachment attached to the linkage is the first attachment than when the attachment attached to the linkage is the second attachment.
